(19) United States
(12) Patent Application Publication
(10) Pub. No.: US 2026/0295529 A1
(43) Pub. Date: Oct. 1, 2026

(54) CONTROL METHOD OF AFTERTREATMENT SYSTEM, CONTROL PROGRAM, AFTERTREATMENT SYSTEM, AND ENGINE SYSTEM

(71) Applicant: Yanmar Holdings Co., Ltd., Osaka (JP)

(72) Inventors: Jun Tomita, Osaka (JP); Kazuma Sugimoto, Osaka (JP)

(73) Assignee: Yanmar Holdings Co., Ltd., Osaka (JP)

(21) Appl. No.: 19/540,508

(22) Filed: Feb. 13, 2026

(30) Foreign Application Priority Data
Mar. 25, 2025 (JP) 2025-050186

(51) Int. Cl. B01D 53/94; F02D 41/02

(52) U.S. Cl. CPC B01D 53/9495; F02D 41/029

(57) ABSTRACT

A control method of an aftertreatment system is a control method of the aftertreatment system including a first SCR device, a second SCR device, a first reducing agent supply device, and a second reducing agent supply device. The first SCR device is located on the exhaust path through which the exhaust gas discharged from the engine main body passes. The second SCR device is located on the exhaust path and on the downstream side of the first SCR device in a flow direction of the exhaust gas. The first reducing agent supply device supplies the reducing agent to the first SCR device. The second reducing agent supply device supplies the reducing agent to the second SCR device. The control method of the aftertreatment system includes individually controlling the supply amount of the reducing agent of each of the first reducing agent supply device and the second reducing agent supply device.

### CROSS-REFERENCE

This application claims foreign priority of JP2025-050186 filed Mar. 25, 2025, the disclosures of which is hereby incorporated by reference in its entirety.

### TECHNICAL FIELD

The present disclosure relates to a control method of an aftertreatment system, a control program, an aftertreatment system, and an engine system.

### BACKGROUND ART

As a related art, there is known an aftertreatment system (emission control device) including an SCR device (NOx purification catalyst) in an exhaust pipe through which exhaust gas discharged from an engine main body (internal combustion engine) flows (see, for example, Patent Document 1). The aftertreatment system according to the related art includes a first SCR device provided on the upstream side in a flow direction of the exhaust gas discharged from the internal combustion engine, and a second SCR device provided on the downstream side of the first SCR device in the flow direction of the exhaust gas.

Here, the aftertreatment system according to the related art includes an emission control device (DOC and DPF) that is located between the first SCR device and the second SCR device and captures particulate matter in the exhaust gas. A reducing agent supply device (urea water injection device) for supplying a reducing agent (urea water) is disposed on each of the upstream side of the first SCR device and the upstream side of the second SCR device.

### PRIOR ART DOCUMENT

### Patent document

Patent Document 1: JP-A-2021-131068

### SUMMARY OF INVENTION

### Technical problem

In order to perform passive regeneration (self-regeneration) of the emission control device, nitrogen dioxide (NO₂) obtained by oxidizing nitrogen monoxide (NO) flowing into the emission control device needs to be supplied to the DPF. However, in the related art described above, since the first SCR device located on the upstream side of the emission control device purifies nitrogen monoxide, the amount of nitrogen monoxide flowing into the emission control device decreases, so that the regeneration capability of the emission control device decreases, which may lead to a decrease in exhaust gas purification performance.

An object of the present disclosure is to provide a control method of an aftertreatment system in which exhaust gas purification performance is less likely to deteriorate, a control program, an aftertreatment system, and an engine system.

### Solution to Problem

A control method of an aftertreatment system according to an aspect of the present disclosure is a control method of an aftertreatment system including a first SCR device, a second SCR device, a first reducing agent supply device, and a second reducing agent supply device. The first SCR device is located on an exhaust path through which exhaust gas discharged from an engine main body passes. The second SCR device is located on the exhaust path and on a downstream side of the first SCR device in a flow direction of the exhaust gas. The first reducing agent supply device supplies a reducing agent to the first SCR device. The second reducing agent supply device supplies the reducing agent to the second SCR device. The control method of the aftertreatment system includes individually controlling a supply amount of the reducing agent of each of the first reducing agent supply device and the second reducing agent supply device.

A control program according to an aspect of the present disclosure is a program for causing one or more processors to execute the control method of the aftertreatment system.

An aftertreatment system according to an aspect of the present disclosure includes a first SCR device, a second SCR device, a first reducing agent supply device, a second reducing agent supply device, and a control unit. The first SCR device is located on an exhaust path through which exhaust gas discharged from an engine main body passes. The second SCR device is located on the exhaust path and on a downstream side of the first SCR device in a flow direction of the exhaust gas. The first reducing agent supply device supplies a reducing agent to the first SCR device. The second reducing agent supply device supplies the reducing agent to the second SCR device. The control unit individually controls a supply amount of the reducing agent of each of the first reducing agent supply device and the second reducing agent supply device.

An engine system according to an aspect of the present disclosure includes the aftertreatment system and the engine main body.

### ADVANTAGEOUS EFFECTS OF INVENTION

According to the present disclosure, it is possible to provide the control method of the aftertreatment system in which exhaust gas purification performance is less likely to deteriorate, a control program, an aftertreatment system, and an engine system.

### BRIEF DESCRIPTION OF DRAWINGS

FIG. 1 is a system diagram illustrating a schematic configuration of an engine system according to a first embodiment;

FIG. 2 is a schematic perspective view of an engine main body of the engine system according to the first embodiment;

FIG. 3 is a schematic perspective view of the engine main body of the engine system according to the first embodiment;

FIG. 4 is a schematic left side view of the engine main body of the engine system according to the first embodiment;

FIG. 5 is a schematic diagram mainly illustrating a configuration of an exhaust gas recirculation system of the engine system according to the first embodiment;

FIG. 6 is a schematic diagram mainly illustrating a configuration of an aftertreatment system of the engine system according to the first embodiment;

FIG. 7 is a schematic diagram illustrating an operation in a cooling mode of the exhaust gas recirculation system of the engine system according to the first embodiment;

FIG. 8 is a schematic diagram illustrating an operation in a bypass mode of the exhaust gas recirculation system of the engine system according to the first embodiment;

FIG. 9 is a table illustrating an operation example of the exhaust gas recirculation system of the engine system according to the first embodiment;

FIG. 10 is a flowchart illustrating an operation example of the exhaust gas recirculation system of the engine system according to the first embodiment;

FIG. 11 is a flowchart illustrating an operation example of the exhaust gas recirculation system of the engine system according to the first embodiment;

FIG. 12 is a schematic cross-sectional view of the engine main body of the engine system according to the first embodiment;

FIG. 13 is an enlarged schematic cross-sectional view of the periphery of a connection path of the engine main body of the engine system according to the first embodiment;

FIG. 14 is a partially broken schematic perspective view of the engine main body of the engine system according to the first embodiment;

FIG. 15 is an enlarged schematic cross-sectional view of the periphery of a connection path of an engine main body of an engine system according to a modification of the first embodiment;

FIG. 16 is a schematic diagram mainly illustrating a configuration of the aftertreatment system of the engine system according to the first embodiment;

FIG. 17 is a table illustrating an operation example of the aftertreatment system of the engine system according to the first embodiment;

FIG. 18 is a flowchart illustrating an operation example of the aftertreatment system of the engine system according to the first embodiment;

FIG. 19 is a schematic left side view of an engine system according to a second embodiment; and

FIG. 20 is a schematic plan view of the engine system according to the second embodiment.

### DESCRIPTION OF EMBODIMENTS

Hereinafter, embodiments of the present disclosure will be described with reference to the accompanying drawings. The following embodiments are examples embodying the present disclosure, and are not intended to limit the technical scope of the present disclosure. The drawings referred to in the present disclosure are all schematic views, and the ratio of the size and thickness of each component in the drawings does not necessarily reflect the actual dimensional ratio.

### First embodiment

### 1. Overall configuration

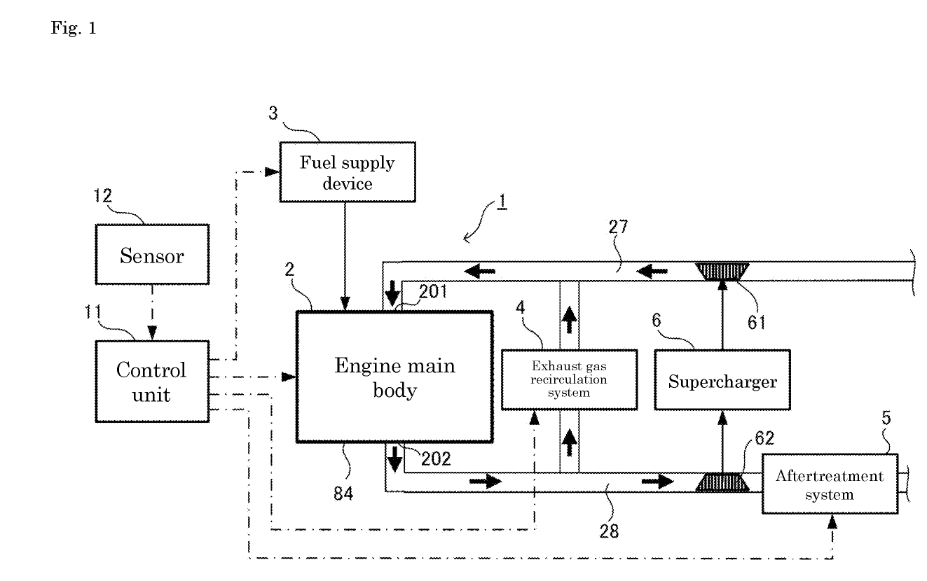

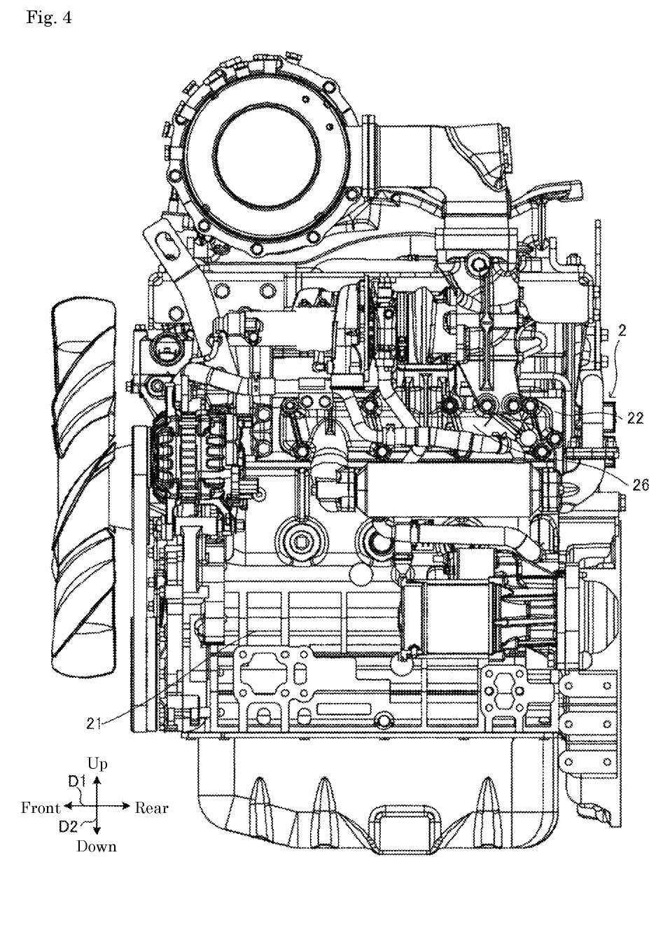

First, an overall configuration of an engine system 1 according to a first embodiment will be described with reference to FIGS. 1 to 6. In FIG. 1, a configuration of each part of the engine system 1 is schematically illustrated, and an electrical connection relationship is indicated by the alternate long and short dash line arrows (in directions in which electrical signals flow).

As illustrated in FIG. 1, the engine system 1 according to the embodiment includes an engine main body 2, which is a main configuration of the engine system 1. The term "engine" referred to herein is a heat engine that combusts fuel to generate mechanical energy (power), and includes an internal combustion engine being a prime mover that combusts fuel inside the engine and converts thermal energy into mechanical energy by use of combustion gas as operational gas. That is, the engine main body 2 generates power (mechanical energy) using the supplied fuel.

The engine main body 2 according to the embodiment is a reciprocating engine that converts reciprocating motion of a piston into rotational motion and outputs rotational force as power. In particular, in the embodiment, a diesel engine using at least light oil as fuel, that is, a diesel reciprocating engine will be described as an example of the engine main body 2.

The engine system 1 is used for, for example, moving objects such as work vehicles for various types of work, ships, and flying objects. Examples of the work vehicle include agricultural machines such as a tractor, a rice transplanter, and a combine, and construction machines such as a backhoe (including a hydraulic excavator, a mini excavator, and the like), a wheel loader, and a carrier. The ship includes a merchant ship including a pleasure boat, a cargo ship, a cargo-passenger ship, and the like, a work ship including a tugboat, a salvage ship, and the like, a special ship including a weather observation ship, a training ship, and the like, a fishing boat, a warship, and the like. The flying object includes a drone, a multicopter, or the like.

The engine system 1 is mounted on a machine body of the moving object. That is, the moving object according to the embodiment includes the engine system 1 and the machine body. The engine system 1 is used as a driving source for generating a propulsive force for propelling the machine body and/or a driving force for driving an implement or the like. In the embodiment, the engine system 1 can also be used as a driving source for driving a generator that produces electrical energy (electrical power) used in the machine body. That is, the engine system 1 is used as a driving source for generating the propulsive force of the machine body of the moving object and/or a driving force, or for driving the generator. The electrical energy produced by the generator may be stored in an electrical storage device.

In the embodiment, as an example, the engine system 1 is used for a tractor used for work in a field. The tractor is a type of work vehicle that travels in the field using power generated by the engine system 1. The tractor drives rear wheels, which are drive wheels, by the power generated by the engine system 1 to generate the propulsive force for moving the machine body forward or backward.

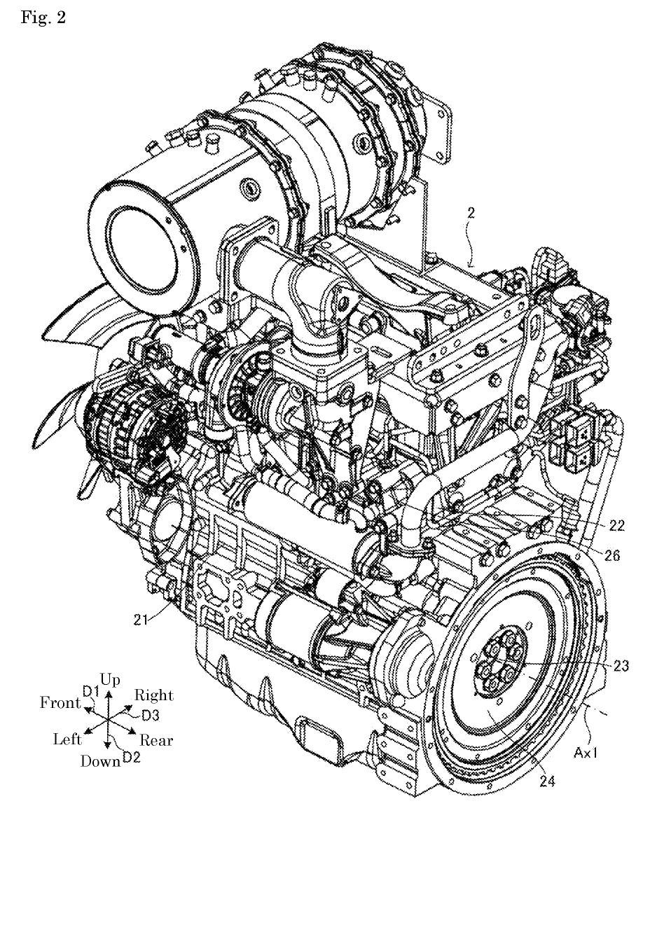

The engine main body 2 is mounted, for example, in a hood of the machine body of the tractor. Here, as illustrated in FIGS. 2 to 4, the engine main body 2 is disposed in a posture in which a cylinder block 21 and a cylinder head 22 are stacked in an up-down direction D2. Specifically, the engine main body 2 is disposed in such a posture that the cylinder head 22 is located above the cylinder block 21 and a rotation axis Ax1 of a crankshaft 23 is oriented in a substantially horizontal direction.

Moreover, in the embodiment, the moving object (tractor) on which the engine system 1 is mounted is configured to operate in response to an operation (including remote control) by a person (operator), and is particularly a manned type where a person who is an operator can board. Therefore, the moving object includes an operation device that receives an operation by the operator in the machine body, and a control unit 11 (see FIG. 1) of the engine system 1 drives the engine main body 2 in response to the operation on the operation device. Accordingly, the moving object can drive the engine main body 2 in response to the operation of the operator and rotate the drive wheels to move the machine body forward or backward.

Moreover, in the embodiment, a direction along the rotation axis Ax1 of the crankshaft 23 is defined as an output shaft direction D1 for convenience of description as illustrated in FIG. 2. Further, as illustrated in FIG. 2, a direction orthogonal to the output shaft direction D1 and along the vertical direction in a state in which the engine main body 2 can be used is defined as the up-down direction D2, and a direction orthogonal to both the output shaft direction D1 and the up-down direction D2 is defined as a width direction D3. Here, one side in the output shaft direction D1 is defined as “front side”, the other side is defined as “rear side”, and a side of the crankshaft 23 on which a flywheel 24 is disposed is defined as rear. Similarly, one side in the width direction D3 is defined as "left side", and the other side is defined as "right side". Further, in the up-down direction D2, a side on which the cylinder head 22 is located as viewed from the cylinder block 21 is defined as “upper”, and the opposite side is defined as “lower”.

In other words, each direction used in the embodiment is a direction defined with reference to the rotation axis Ax1 of the crankshaft 23. However, these directions are not intended to limit the use direction (direction at the time of use) of the engine main body 2.

In the engine main body 2, the rotational force of the crankshaft 23 as an engine output shaft is taken out as an output. The drive wheel or the like is coupled to the crankshaft 23 via a transmission device or the like. When the engine main body 2 is driven to rotate the crankshaft 23 about the rotation axis Ax1, the driving wheels rotate to enable the tractor to travel.

As described above, the engine system 1 according to the embodiment is a diesel engine. Therefore, the engine main body 2 is configured such that fuel (here, light oil) can be supplied to the engine main body 2 from the outside thereof. That is, as illustrated in FIG. 1, the engine system 1 includes a fuel supply device 3 for supplying fuel.

Moreover, as illustrated in FIG. 1, the engine system 1 according to the embodiment further includes an exhaust gas recirculation system 4, an aftertreatment system 5, and the control unit 11. The exhaust gas recirculation system 4 is a system that recirculates, as exhaust gas recirculation (EGR) gas, at least part of exhaust gas discharged from the engine main body 2 from an exhaust port 202 to an intake port 201 of the engine main body 2. The aftertreatment system 5 is a system for purifying the exhaust gas discharged from the engine main body 2. That is, the engine system 1 includes the fuel supply device 3, the exhaust gas recirculation system 4, and the aftertreatment system 5 in addition to the engine main body 2.

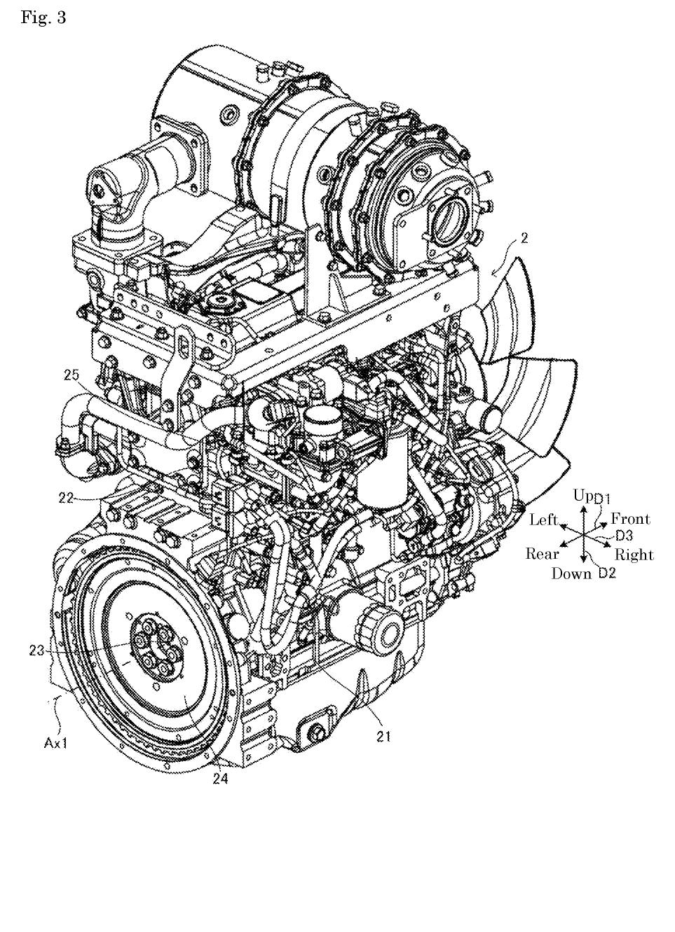

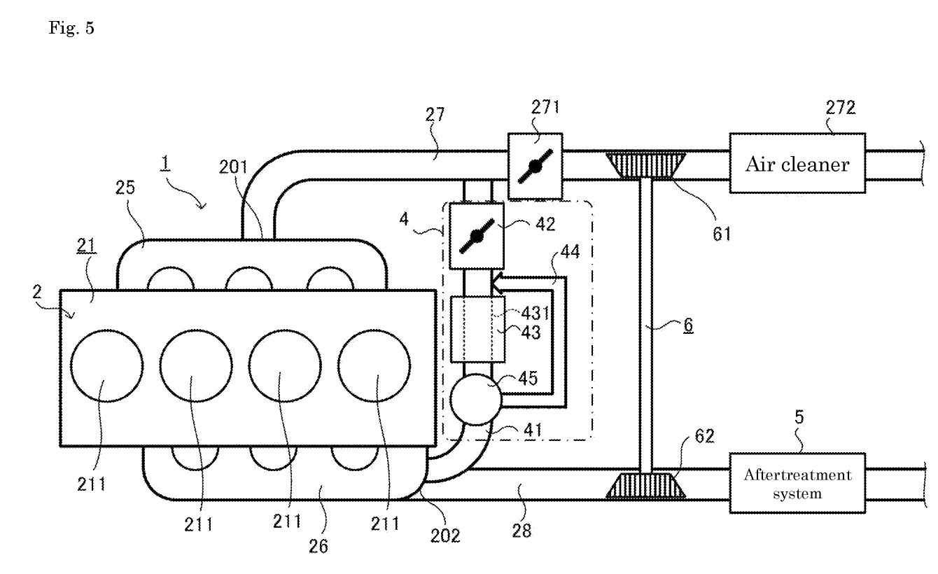

As illustrated in FIGS. 2 to 4, the engine main body 2 is configured by assembling the cylinder head 22 on the cylinder block 21. The cylinder block 21 includes cylinders 211 (see FIG. 5) and a crankcase. The cylinder head 22 includes intake ports and exhaust ports. As illustrated in FIGS. 2 and 3, the crankshaft 23 is rotatably supported by the cylinder block 21 in a state in which the rotation axis Ax1 is oriented in the output shaft direction D1.

In the cylinder block 21, the plurality of (four in the embodiment as an example) cylinders 211 are formed in line (in series) along the rotation axis Ax1 of the crankshaft 23. That is, in the embodiment, the engine main body 2 is an in-line multi-cylinder engine (in-line four-cylinder engine) in which the plurality of cylinders 211 are arranged in series. The output shaft direction D1 along the rotation axis Ax1 of the crankshaft 23 coincides with the arrangement direction of the plurality of cylinders 211. In each cylinder 211, a piston is housed so as to be slidable in the up-down direction D2, that is, capable of reciprocating. The piston is coupled to the crankshaft 23 via a connecting rod.

The cylinder head 22 is fixed above the cylinder block 21 so as to cover the plurality of cylinders 211 from above. In an internal space of each cylinder 211, a space surrounded by an upper surface of the piston and a lower surface of the cylinder head 22 functions as a combustion chamber. That is, when the piston reciprocates in the up-down direction D2, the combustion chamber alternately repeats expansion and contraction.

For example, a valve operating mechanism including a push rod, a rocker arm, and the like for operating an intake valve and an exhaust valve is mounted on the cylinder head 22. The intake valve opens and closes an opening leading to the combustion chamber among the intake ports formed in the cylinder head 22. The exhaust valve opens and closes an opening leading to the combustion chamber among the exhaust ports formed in the cylinder head 22. Accordingly, in a state in which the intake valve is opened, air (intake air) from the intake port can be taken into the combustion chamber. In a state in which the exhaust valve is opened, exhaust gas from the combustion chamber can be discharged to the exhaust port.

Moreover, the engine main body 2 includes an intake manifold 25 for distributing and supplying air (supplied air) from the outside of the engine main body 2 to the inside of the engine main body 2 (combustion chamber of each cylinder 211). The engine main body 2 further includes an exhaust manifold 26 for collecting exhaust gas generated by combustion in the combustion chamber of each cylinder 211 and discharging the collected exhaust gas to the outside of the engine main body 2.

As illustrated in FIG. 3, the intake manifold 25 is disposed on the right side of the cylinder head 22. The intake manifold 25 extends in the output shaft direction D1 and is connected to the plurality of intake ports formed in the cylinder head 22. Accordingly, air is distributed from the intake manifold 25 to the plurality of intake ports. That is, the intake manifold 25 leads to the combustion chamber of each cylinder 211 through the intake port.

As illustrated in FIG. 2, the exhaust manifold 26 is disposed on the left side of the cylinder head 22. The exhaust manifold 26 extends in the output shaft direction D1 and is connected to the plurality of exhaust ports formed in the cylinder head 22. Accordingly, exhaust gas from the plurality of exhaust ports is collected in the exhaust manifold 26. That is, the exhaust manifold 26 leads to the combustion chamber of each cylinder 211 through the exhaust port.

Main components constituting the engine main body 2, such as the cylinder block 21, the cylinder head 22, the intake manifold 25, and the exhaust manifold 26, are made of a metal material such as an aluminum alloy and cast iron, for example. These main components have desired durability (including rigidity, abrasion resistance, and the like) and relatively excellent thermal conductivity.

According to the above configuration, when the engine main body 2 is driven, the fuel is injected from the fuel supply device 3 into the combustion chamber at an appropriate timing when the air supplied from the intake manifold 25 to each cylinder 211 is compressed by the sliding of the piston. When the fuel is injected into the combustion chamber, the piston reciprocates in the cylinder 211 by the propulsive force obtained from explosion generated in the combustion chamber, and the reciprocating motion of the piston is converted into the rotational motion of the crankshaft 23 through the connecting rod. Accordingly, the engine main body 2 outputs the rotational force of the crankshaft 23 as power (mechanical energy).

When the engine main body 2 is driven, the exhaust gas generated by combustion (explosion) in the combustion chamber is pushed out of the cylinder 211 by the movement of the piston, collected in the exhaust manifold 26 through the exhaust port, and then discharged to the outside of the engine main body 2.

The fuel supply device 3 includes an injection portion connected to a fuel tank via a fuel supply path. The fuel supply device 3 injects fuel supplied through the fuel supply path into the engine main body 2 from the injection portion having a nozzle shape (cylindrical shape). Here, the injection portion is disposed at a position facing the combustion chamber. Accordingly, the injection portion directly injects the fuel into the combustion chamber.

The exhaust gas recirculation system 4 re-introduces (recirculates) part of the exhaust gas generated in the engine main body 2 into the engine main body 2. The exhaust gas recirculation system 4 is connected between the intake port 201 serving as an air taking-in port and the exhaust port 202 in the engine main body 2. In the embodiment, as illustrated in FIG. 5, a connection portion of an intake path 27 in the intake manifold 25 is the intake port 201, and a connection portion of an exhaust path 28 in the exhaust manifold 26 is the exhaust port 202. That is, the exhaust gas recirculation system 4 is inserted between the intake path 27 for taking air into the intake manifold 25 and the exhaust path 28 leading to the exhaust manifold 26.

The exhaust gas recirculation system 4 recirculates, as EGR gas, at least part of air (exhaust gas) discharged from the engine main body 2 from the exhaust port 202 (of the exhaust manifold 26) to the intake port 201 (of the intake manifold 25) of the engine main body 2. That is, the EGR gas is part of the air (exhaust gas) discharged from the exhaust manifold 26 of the engine main body 2, and is the air re-introduced (recirculated) into the intake manifold 25 of the engine main body 2. The exhaust gas recirculation system 4 reduces a combustion temperature by recirculating the EGR gas, thereby contributing to suppression of generation of nitrogen oxides (NOx) and improvement of fuel efficiency.

The aftertreatment system 5 purifies the exhaust gas discharged from the engine main body 2 to satisfy a desired emission control as the engine system 1. The aftertreatment system 5 is inserted into the exhaust path 28 leading to the exhaust port 202 (of the exhaust manifold 26) of the engine main body 2. Accordingly, the air (exhaust gas) discharged to the outside of the engine system 1 through the exhaust path 28 passes through the aftertreatment system 5 and is purified by the aftertreatment system 5.

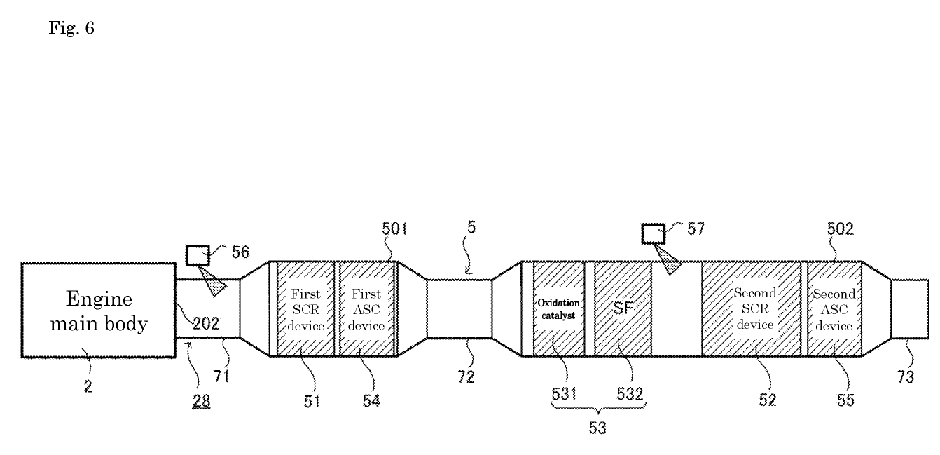

In the embodiment, as illustrated in FIG. 6, the aftertreatment system 5 includes a first selective catalytic reduction (SCR) device 51, a second SCR device 52, and the emission control device 53. The first SCR device 51 is also simply referred to as an "SCR device 51".

Each of the first SCR device 51 and the second SCR device 52 converts nitrogen oxides (NOx) in the exhaust gas passing through the exhaust path 28 into nitrogen molecules (N₂) and water (H₂O) by a catalyst, thereby reducing nitrogen oxides in the exhaust gas.

Each of the first SCR device 51 and the second SCR device 52 is a catalyst that reduces nitrogen oxides in the exhaust gas to nitrogen by ammonia generated from urea water (an example of a reducing agent) injected into the exhaust path 28. Here, since urea water, which is an example of the reducing agent, is hydrolyzed by exhaust heat (heat of exhaust gas) of the engine main body 2, the urea water becomes ammonia gas by being sprayed onto the exhaust gas. With such a mechanism, each of the first SCR device 51 and the second SCR device 52 purifies the exhaust gas by reducing nitrogen oxides in the exhaust gas.

The emission control device 53 captures particulate matter in the exhaust gas passing through the exhaust path 28. In the embodiment, as illustrated in FIG. 6, the emission control device 53 is located between the first SCR device 51 and the second SCR device 52 in the exhaust path 28. The emission control device 53 is a diesel particulate filter (DPF) device that captures (collects) particulate matter (PM) such as soot contained in the exhaust gas.

That is, the emission control device 53 includes an oxidation catalyst (diesel oxidation catalyst (DOC)) 531 and a soot filter (SF) 532. The emission control device 53 decomposes particulate matter in the exhaust gas by the oxidation catalyst 531 and collects the particulate matter by the soot filter 532, thereby preventing release of harmful substances into the atmosphere. Since the particulate matter captured by the soot filter 532 causes clogging of the soot filter 532 as it is, it is necessary to regenerate the soot filter 532 in the emission control device 53.

The control unit 11 mainly includes a computer system including one or more processors such as a central processing unit (CPU) and one or more memories such as a read only memory (ROM) and a random access memory (RAM), and executes various types of processing (information processing). A program (engine control program) for causing the one or more processors to execute an engine control method is recorded in the one or more memories in the control unit 11.

The control unit 11 outputs a control signal (electric signal) to the engine main body 2, the fuel supply device 3, the exhaust gas recirculation system 4, the aftertreatment system 5, and the like to control the engine main body 2, the fuel supply device 3, the exhaust gas recirculation system 4, the aftertreatment system 5, and the like. Accordingly, the control unit 11 can, for example, control the engine main body 2 so as to adjust the output (mainly the rotation speed) of the engine main body 2 to an arbitrary value. Further, the control unit 11 can also control an intake throttle valve 271 (see FIG. 5). The intake throttle valve 271 is disposed on the downstream side of a compressor 61 in the flow of intake air in the intake path 27.

Moreover, the engine system 1 according to the embodiment is a supercharged engine including a supercharger 6 (see FIG. 1) in addition to the engine main body 2. However, the supercharger 6 is not an essential component of the engine system 1, and can be omitted as appropriate.

As illustrated in FIG. 5, the supercharger 6 includes the compressor 61 and a turbine 62. The compressor 61 is disposed on the intake path 27 for taking air into the intake manifold 25. The turbine 62 is disposed on the exhaust path 28 leading to the exhaust manifold 26.

The turbine 62 is coupled to the compressor 61, and when the turbine 62 rotates by a flow of air (exhaust gas) discharged through the exhaust path 28, the compressor 61 rotates. When the compressor 61 rotates, air (intake air) taken in from the intake path 27 is compressed and sent to the intake manifold 25 through an intercooler. The intercooler cools the air (intake air) compressed by the supercharger 6. The thick arrows in FIG. 1 represent a flow (air flow) of air (including intake air and exhaust gas).

The engine system 1 according to the embodiment further includes an air cleaner 272 (see FIG. 5), various sensors 12 (see FIG. 1), and the like in addition to the above-described configuration (the engine main body 2, the fuel supply device 3, the exhaust gas recirculation system 4, the aftertreatment system 5, the control unit 11, and the supercharger 6).

The air cleaner 272 is disposed on the upstream side of the compressor 61 in the flow of intake air in the intake path 27. The sensor 12 includes a rotation speed sensor that detects the rotation speed of the engine main body 2, a temperature sensor that measures the temperature of exhaust gas or the like, a pressure sensor that measures the pressure of exhaust gas or the like, and the like. The sensor 12 outputs an electric signal corresponding to the measurement value (rotation speed, temperature, pressure, or the like) to the control unit 11.

### 2. Details of exhaust gas recirculation system

Next, details of the exhaust gas recirculation system 4 according to the embodiment will be described with reference to FIGS. 5 and 7 to 11.

As illustrated in FIG. 5, the exhaust gas recirculation system 4 includes an EGR path 41, an EGR valve 42, a cooling unit 43, a bypass path 44, and a switching valve 45. Here, the control unit 11 can control the exhaust gas recirculation system 4, specifically, the EGR valve 42 and the switching valve 45, and thus is regarded as a component of the exhaust gas recirculation system 4.

The EGR path 41 is a pipe that connects the exhaust port 202 and the intake port 201 of the engine main body 2 and allows gas (EGR gas) to pass through the EGR path 41. Specifically, the EGR path 41 branches from the exhaust path 28 leading to the exhaust port 202 of the exhaust manifold 26 and connects with the intake path 27, thereby connecting the exhaust port 202 and the intake port 201. Such an EGR path 41 enables the EGR gas composed of at least part of the exhaust gas to recirculate from the exhaust port 202 to the intake port 201 of the engine main body 2.

The EGR valve 42 is inserted into the EGR path 41. The EGR valve 42 can adjust the flow rate of the EGR gas recirculated from the exhaust port 202 to the intake port 201 of the engine main body 2 through the EGR path 41. That is, the flow rate of the EGR gas increases as the opening degree of the EGR valve 42 increases, and the flow rate of the EGR gas decreases as the opening degree of the EGR valve 42 decreases. In a state in which the EGR valve 42 is completely closed, the EGR gas flowing through the EGR path 41 is blocked, and the recirculation of the EGR gas from the exhaust port 202 to the intake port 201 is stopped. In the embodiment, the EGR valve 42 is an electromagnetic valve whose opening degree is adjustable, and the opening degree of the EGR valve 42 is adjustable by a control signal from the control unit 11.

The cooling unit 43 is an EGR cooler that cools the EGR gas. The cooling unit 43 is inserted into the EGR path 41 so as to be connected in series with the EGR valve 42 on the EGR path 41. The cooling unit 43 includes a cooling path 431 included in the EGR path 41 and cools the EGR gas passing through the cooling path 431. The cooling unit 43 cools the EGR gas passing through the cooling path 431 by heat exchange with the cooling path 431 using a refrigerant such as cooling water, for example. In the embodiment, as an example, the cooling unit 43 uses, as a refrigerant, cooling water for cooling the engine main body 2.

The bypass path 44 is a pipe that connects an inlet and an outlet of the cooling path 431 and allows gas (EGR gas) to pass through the bypass path 44. The bypass path 44 is inserted into the EGR path 41 so as to be connected in series with the EGR valve 42 on the EGR path 41. Here, the bypass path 44 is connected in parallel on the EGR path 41 connecting the exhaust port 202 and the intake port 201. Therefore, when the EGR gas passes through the bypass path 44, (the cooling path 431 of) the cooling unit 43 is bypassed.

The switching valve 45 is inserted into the EGR path 41. The switching valve 45 is located on the EGR path 41 and on the upstream side (that is, on the exhaust port 202 side) of (the cooling path 431 of) the cooling unit 43 and the bypass path 44 in the flow direction of the EGR gas. The switching valve 45 is located at a branch point between (the cooling path 431 of) the cooling unit 43 and the bypass path 44, and switches a path through which the EGR gas passes between (the cooling path 431 of) the cooling unit 43 and the bypass path 44. That is, according to the switching valve 45, the EGR gas passing through the EGR path 41 passes through either (the cooling path 431 of) the cooling unit 43 or the bypass path 44. In the embodiment, the switching valve 45 is an electromagnetic valve that switches a connection destination of the exhaust port 202 between (the cooling path 431 of) the cooling unit 43 and the bypass path 44, and the switching valve 45 is switchable with a control signal from the control unit 11.

Here, the EGR valve 42, the cooling unit 43, the bypass path 44, and the switching valve 45 are connected in the order of the switching valve 45, the cooling unit 43, the bypass path 44, and the EGR valve 42 from the upstream side (that is, the exhaust port 202 side) in the flow direction of the EGR gas.

According to the above configuration, when the EGR valve 42 is in an open state, the exhaust gas recirculation system 4 can recirculate, as EGR gas, at least part of the exhaust gas discharged from the engine main body 2 from the exhaust port 202 to the intake port 201 of the engine main body 2.

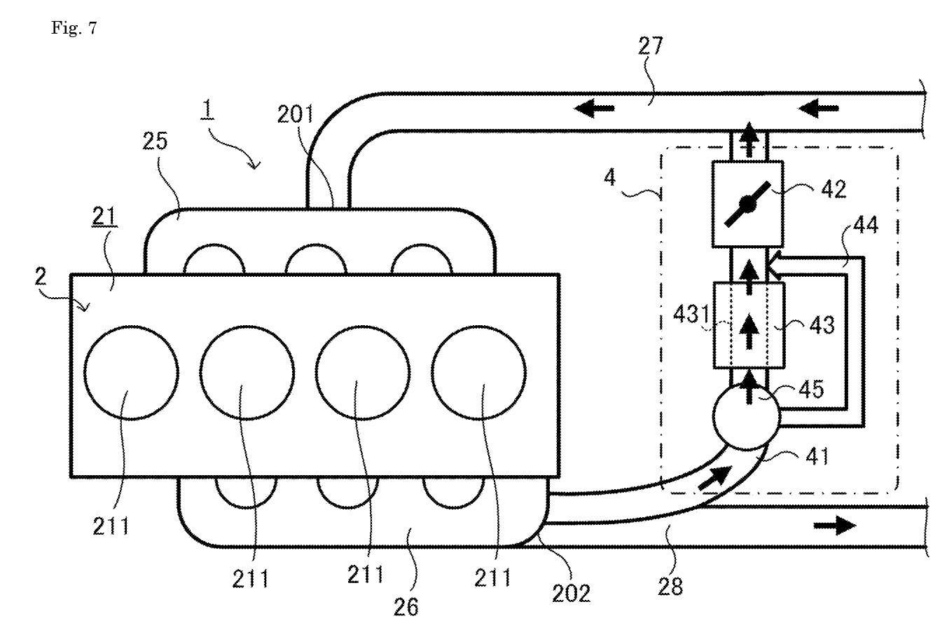

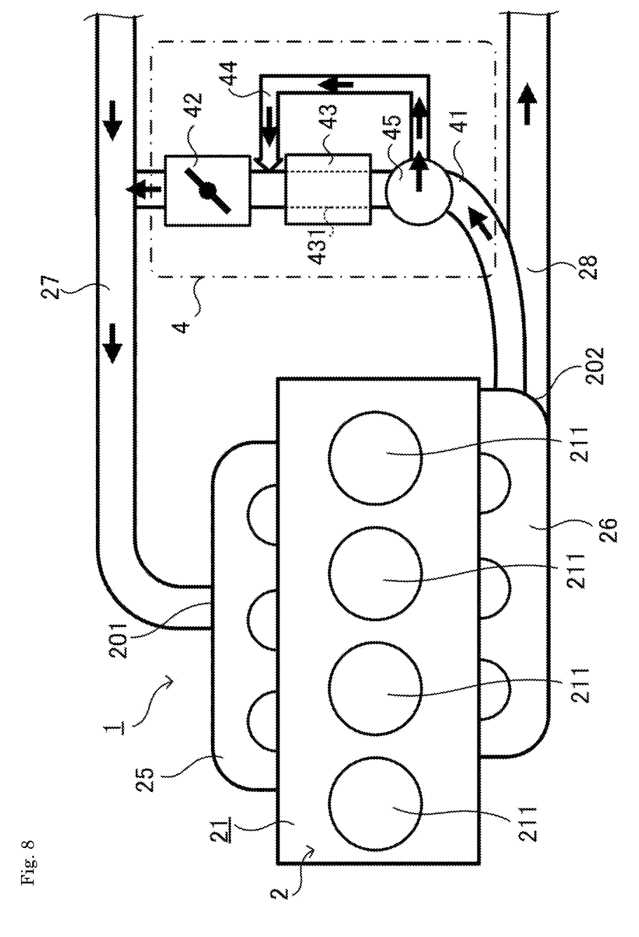

The exhaust gas recirculation system 4 can switch between a cooling mode illustrated in FIG. 7 and a bypass mode illustrated in FIG. 8 with the switching valve 45. That is, the cooling mode and the bypass mode are prepared as the operation mode of the exhaust gas recirculation system 4 that recirculates the EGR gas.

As illustrated in FIG. 7, the cooling mode is an operation mode in which (the cooling path 431 of) the cooling unit 43 is selected as a path through which the EGR gas passes by the switching valve 45. When the operation mode of the exhaust gas recirculation system 4 is the cooling mode with the EGR valve 42 in the open state, the EGR gas is recirculated from the exhaust port 202 to the intake port 201 of the engine main body 2 through (the cooling path 431 of) the cooling unit 43. Therefore, the EGR gas passing through the EGR path 41 is cooled by the cooling unit 43, and the temperature of the EGR gas decreases when the EGR gas passes through the EGR path 41.

On the other hand, as illustrated in FIG. 8, the bypass mode is an operation mode in which the bypass path 44 is selected as a path through which the EGR gas passes by the switching valve 45. When the operation mode of the exhaust gas recirculation system 4 is the bypass mode with the EGR valve 42 in the open state, the EGR gas is recirculated from the exhaust port 202 to the intake port 201 of the engine main body 2 through the bypass path 44. Therefore, the EGR gas passing through the EGR path 41 does not pass through (the cooling path 431 of) the cooling unit 43, and the temperature of the EGR gas does not decrease when the EGR gas passes through the EGR path 41.

In the embodiment, when a determination condition is satisfied, the control unit 11 recirculates the EGR gas in the bypass mode in which the EGR gas is caused to flow through the bypass path 44 to bypass the cooling path 431. That is, the control unit 11 controls the switching valve 45 depending on whether the determination condition is satisfied; the control unit 11 selects the bypass mode when the determination condition is satisfied, and selects the cooling mode when the determination condition is not satisfied. Specifically, the control unit 11 determines whether a predetermined determination condition is satisfied, and then recirculates the EGR gas in the bypass mode when the determination condition is satisfied.

In short, the exhaust gas recirculation system 4 according to the embodiment can switch between the two operation modes: the cooling mode and the bypass mode, in a state of "EGR ON" in which the EGR valve 42 is opened to recirculate the EGR gas. Therefore, the exhaust gas recirculation system 4 can switch three states: a state of “EGR OFF” in which the EGR valve 42 is closed to stop recirculation of the EGR gas, a state of “EGR ON” and the cooling mode, and a state of “EGR ON” and the bypass mode.

As described above, the exhaust gas recirculation system 4 according to the embodiment is a system that recirculates, as EGR gas, at least part of the exhaust gas discharged from the engine main body 2 from the exhaust port 202 to the intake port 201 of the engine main body 2. The exhaust gas recirculation system 4 includes the EGR path 41, the cooling unit 43, the bypass path 44, and the control unit 11. The EGR path 41 connects the exhaust port 202 and the intake port 201 and allows the EGR gas to pass through the EGR path 41. The cooling unit 43 includes a cooling path 431 included in the EGR path 41 and cools the EGR gas passing through the cooling path 431. The bypass path 44 connects the inlet (upstream side in the flow direction of the EGR gas) and the outlet (downstream side in the flow direction of the EGR gas) of the cooling path 431. The control unit 11 recirculates the EGR gas in the bypass mode in which the EGR gas is caused to flow through the bypass path 44 to bypass the cooling path 431 when the determination condition is satisfied.

According to this configuration, for example, under a specific situation such as when the temperature of the exhaust gas is extremely low, it is possible to recirculate the EGR gas in the bypass mode in which the EGR gas is caused to flow through the bypass path 44 to bypass the cooling path 431. Accordingly, it is possible to suppress subcooling of the EGR gas by the cooling unit 43 while recirculating the EGR gas even under the specific situation, and to suppress the generation of incomplete combustion products (engine deposits) in the EGR valve 42 and the like. As a result, in the embodiment, it is possible to provide the exhaust gas recirculation system 4 in which the engine deposits are less likely to be generated, the engine system 1 including the exhaust gas recirculation system 4, a control method of the exhaust gas recirculation system 4, and control program.

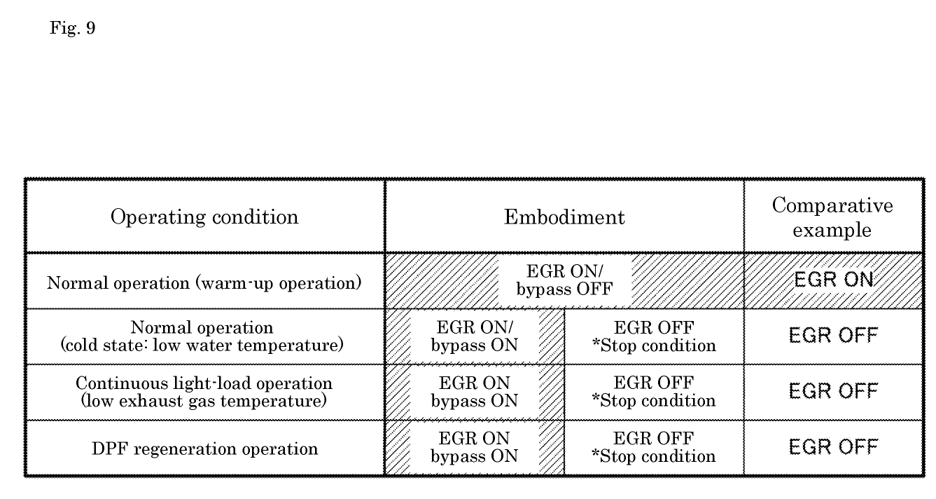

More specifically, for example, when the engine main body 2 performs continuous operation with a light load (low load), the temperature of the exhaust gas does not sufficiently rise, resulting in a "low exhaust gas temperature" state in which the temperature of the exhaust gas becomes relatively low. When the exhaust gas recirculation system 4 recirculates the EGR gas in the cooling mode in which the EGR gas is caused to flow through the cooling path 431 to be cooled in the “low exhaust gas temperature” state, subcooling of the EGR gas occurs, which may cause the accumulation of engine deposits in the EGR valve 42 and the like. The accumulation of engine deposits may lead to problems such as a decrease in the flow rate of the EGR gas recirculated through the EGR path 41 to deteriorate emission, or the occurrence of malfunction of the EGR valve 42 or the like when the accumulation amount of the engine deposits becomes excessive. Therefore, in order to avoid these problems, it is conceivable to close the EGR valve 42 to stop the recirculation of the EGR gas (EGR OFF) in the “low exhaust gas temperature” state in the first place (a comparative example of FIG. 9).

On the other hand, in the exhaust gas recirculation system 4 according to the embodiment, the EGR gas is recirculated in the bypass mode when the determination condition is satisfied, so that the EGR valve 42 can be opened to recirculate the EGR gas (EGR ON) even in the “low exhaust gas temperature” state, for example. That is, the exhaust gas recirculation system 4 according to the embodiment can suppress subcooling of the EGR gas while recirculating the EGR gas, for example, in the “low exhaust gas temperature” state, and can avoid the above-described problems caused by the engine deposits.

Moreover, the exhaust gas recirculation system 4 according to the embodiment includes the EGR valve 42 that adjusts the flow rate of the EGR gas passing through the EGR path 41. Accordingly, the flow rate of the EGR gas to be recirculated can be adjusted by the opening degree of the EGR valve 42. Moreover, by recirculating the EGR gas in the bypass mode when the determination condition is satisfied, it is possible to suppress the accumulation of engine deposits in the EGR valve 42.

Moreover, the exhaust gas recirculation system 4 according to the embodiment includes the switching valve 45 disposed on the EGR path 41. The switching valve 45 switches the path through which the EGR gas passes between (the cooling path 431 of) the cooling unit 43 and the bypass path 44. Accordingly, it is possible by the control of the switching valve 45 to switch between the cooling mode in which the EGR gas is cooled and the bypass mode in which the EGR gas is caused to flow through the bypass path 44 to bypass (the cooling path 431 of) the cooling unit 43.

In the embodiment, the determination condition includes a condition related to the temperature of the exhaust gas. That is, the control unit 11 determines whether the determination condition is satisfied based on the temperature of the exhaust gas measured by the temperature sensor included in the sensor 12. The temperature of the exhaust gas is measured, for example, in the vicinity of the exhaust port 202 of the exhaust manifold 26. As an example, the determination condition includes that the temperature of the exhaust gas is equal to or lower than a predetermined exhaust gas reference temperature and/or that the rate of change in the temperature of the exhaust gas per unit time is equal to or lower than a predetermined value. Accordingly, the exhaust gas recirculation system 4 can suppress subcooling of the EGR gas while recirculating the EGR gas, for example, in the “low exhaust gas temperature” state, and can avoid the above-described problems caused by the engine deposits.

Moreover, the determination condition includes that the flow of the EGR gas is stabilized. That is, on condition that the EGR gas flow is stabilized, the control unit 11 recirculates the EGR gas in the bypass mode in which the EGR gas is caused to flow through the bypass path 44 to bypass the cooling path 431. Accordingly, it is possible to avoid recirculation of the EGR gas in the bypass mode in a state in which the flow of the EGR gas is unstable, and it is easy to suppress subcooling of the EGR gas.

Here, when a state in which the temperature of the EGR gas is equal to or lower than an EGR gas reference temperature continues for a certain period of time, the control unit 11 determines that the flow of the EGR gas is stable. That is, the control unit 11 determines whether the flow of the EGR gas as the determination condition is stable based on whether the state in which the temperature of the EGR gas is equal to or lower than the EGR gas reference temperature continues for a certain period of time. Specifically, the control unit 11 determines whether the determination condition is satisfied based on the temperature of the EGR gas measured by the temperature sensor included in the sensor 12. The temperature of the EGR gas is measured, for example, at a position between the cooling unit 43 and the EGR valve 42 in the EGR path 41. Accordingly, it is possible to determine whether the flow of the EGR gas is stable without directly monitoring the flow of the EGR gas.

Moreover, in the embodiment, the determination condition includes a condition related to the temperature of the refrigerant for cooling the engine main body 2. In the embodiment, the refrigerant (cooling water) for cooling the engine main body 2 is also used for cooling the EGR gas in the cooling unit 43. The control unit 11 determines whether the determination condition is satisfied based on the temperature of the refrigerant measured by the temperature sensor included in the sensor 12. The temperature of the refrigerant is measured, for example, in the cooling unit 43. As an example, the determination condition includes that the temperature of the refrigerant is equal to or lower than a predetermined refrigerant reference temperature and/or that the rate of change in the temperature of the refrigerant per unit time is equal to or lower than a predetermined value. Accordingly, the exhaust gas recirculation system 4 can suppress the subcooling of the EGR gas while recirculating the EGR gas in a “low water temperature” state in which the temperature of the refrigerant does not rise and the temperature of the refrigerant is relatively low as immediately after the start of the engine main body 2, for example.

Further, the control unit 11 stops the recirculation of the EGR gas when the temperature of the exhaust gas is equal to or lower than a first reference temperature and the temperature of the refrigerant (cooling water) for cooling the engine main body 2 is equal to or lower than the refrigerant reference temperature. That is, when the temperature of the exhaust gas is equal to or lower than the first reference temperature and the temperature of the refrigerant for cooling the engine main body 2 is equal to or lower than the refrigerant reference temperature, the control unit 11 determines that a stop condition is satisfied, and closes the EGR valve 42 to stop the recirculation of the EGR gas (EGR OFF). Accordingly, when the temperature of the exhaust gas is extremely low and the temperature of the refrigerant is relatively low, the recirculation of the EGR gas is stopped, and the accumulation of engine deposits can be avoided.

Here, the determination condition includes that the temperature of the exhaust gas is higher than the first reference temperature and equal to or lower than a second reference temperature and the temperature of the refrigerant is equal to or lower than the refrigerant reference temperature. The second reference temperature is higher than the first reference temperature. That is, even if the temperature of the refrigerant is equal to or lower than the refrigerant reference temperature, when the temperature of the exhaust gas is not equal to or lower than the first reference temperature (higher than the first reference temperature) and is equal to or lower than the second reference temperature, the control unit 11 performs the recirculation of the EGR gas in the bypass mode instead of stopping the recirculation of the EGR gas. Accordingly, it is possible to recirculate the EGR gas as much as possible while suppressing the subcooling of the EGR gas.

Moreover, in the embodiment, the control unit 11 is capable of switching the recirculation and stop of the EGR gas at the time of regeneration of the emission control device 53 that captures the particulate matter in the exhaust gas. That is, although it is necessary to regenerate the soot filter 532 in the emission control device 53, the control unit 11 is capable of switching the recirculation and stop of the EGR gas by controlling the EGR valve 42 at the time of the regeneration.

At the time of regeneration of the emission control device 53, unburned fuel may be sent to the oxidation catalyst 531 by post injection to raise the temperature of the exhaust gas. In this case, when the EGR gas excessively contains an unburned fuel component (total hydrocarbon (THC)), engine deposits may be generated due to the unburned fuel component. Therefore, for example, in the comparative example illustrated in FIG. 9, the control unit 11 unconditionally closes the EGR valve 42 to stop the recirculation of the EGR gas (EGR OFF) at the time of regeneration of the emission control device 53 (DPF regeneration operation).

On the other hand, in the embodiment, the recirculation and stop of the EGR gas is switched based on a switching condition instead of unconditionally stopping the recirculation of the EGR gas even at the time of regeneration of the emission control device 53. For example, even at the time of regeneration of the emission control device 53, the recirculation of the EGR gas is allowed under a situation where the engine deposits are less likely to be generated. Accordingly, even at the time of regeneration of the emission control device 53, the recirculation of the EGR gas can be executed as much as possible.

Further, when the control unit 11 switches the recirculation and stop of the EGR gas at the time of regeneration of the emission control device 53 that captures particulate matter in the exhaust gas, switching between the cooling mode and the bypass mode is not essential. That is, the bypass path 44 may be omitted.

In this case, the exhaust gas recirculation system 4 is a system that recirculates, as EGR gas, at least part of the exhaust gas discharged from the engine main body 2 from the exhaust port 202 to the intake port 201 of the engine main body 2. The exhaust gas recirculation system 4 only needs to include the EGR path 41 and the control unit 11. The EGR path 41 connects the exhaust port 202 and the intake port 201 and allows the EGR gas to pass through the EGR path 41. The control unit 11 is capable of switching the recirculation and stop of the EGR gas at the time of regeneration of the emission control device 53 that captures particulate matter in the exhaust gas.

Here, the control unit 11 recirculates the EGR gas when post injection is not performed in the regeneration of the emission control device 53, and stops the recirculation of the EGR gas when post injection is performed in the regeneration of the emission control device 53. That is, the switching condition includes whether post injection is performed. A regeneration mode of the emission control device 53 includes an active (forced) regeneration mode in which post injection is performed and a passive regeneration mode in which post injection is not performed. In the active regeneration mode, unburned fuel is sent to the oxidation catalyst 531 by post injection in which fuel is injected later than a main combustion injection timing to forcibly raise the temperature of the exhaust gas, and particulate matter accumulated on the soot filter 532 is burned.

When the regeneration mode of the emission control device 53 is the active regeneration mode in which post injection is performed at the time of regeneration of the emission control device 53, the control unit 11 closes the EGR valve 42 to stop the recirculation of the EGR gas (EGR OFF). On the other hand, when the regeneration mode of the emission control device 53 is the passive regeneration mode in which post injection is not performed at the time of regeneration of the emission control device 53, the EGR valve 42 is opened to recirculate the EGR gas (EGR ON). Accordingly, the exhaust gas recirculation system 4 can suppress the generation of engine deposits due to the unburned fuel component by stopping the recirculation of the EGR gas at the time of post injection in which the EGR gas may excessively contain the unburned fuel component (THC). At the time of regeneration in which post injection is not performed, the exhaust gas recirculation system 4 can reduce emission by recirculating the EGR gas.

However, when the EGR gas is recirculated at the time of regeneration of the emission control device 53, the control unit 11 performs restricted recirculation. That is, at the time of regeneration of the emission control device 53, the EGR gas is not recirculated similarly to the normal operation of the engine main body 2, but some restriction is imposed on the recirculation of the EGR gas. Accordingly, for example, it is possible to suppress the generation of the engine deposits caused by the unburned fuel component contained in the EGR gas.

In the embodiment, the restricted recirculation performed at the time of regeneration of the emission control device 53 includes the recirculation of the EGR gas in the bypass mode. Accordingly, at the time of regeneration of the emission control device 53, the recirculation of the EGR gas can be performed in the bypass mode instead of stopping the recirculation of the EGR gas. Therefore, it is possible to recirculate the EGR gas as much as possible while suppressing the subcooling of the EGR gas.

FIG. 9 illustrates an operation of the exhaust gas recirculation system 4 according to the embodiment under each operating condition. FIG. 9 also illustrates an operation of an exhaust gas recirculation system according to the comparative example without the bypass path 44.

First, in the exhaust gas recirculation system according to the comparative example, the EGR gas is circulated only during the normal operation (warm-up operation) of the engine main body 2 (EGR ON) as illustrated in FIG. 9. That is, under the operating conditions other than the normal operation (warm-up operation) of the engine main body 2, the exhaust gas recirculation system according to the comparative example stops the circulation of the EGR gas (EGR OFF). Specifically, in the normal operation of the engine main body 2, the circulation of the EGR gas is stopped in the "low water temperature" state (cold state: low water temperature) in which the temperature of the refrigerant does not rise and the temperature of the refrigerant is relatively low, a "continuous light-load operation (low exhaust gas temperature)" state in which the engine main body 2 performs continuous operation with a light load, and the like. Further, the recirculation of the EGR gas is stopped also at the time of regeneration of the emission control device 53 (DPF regeneration operation).

On the other hand, in the exhaust gas recirculation system 4 according to the embodiment, the EGR gas is circulated (EGR ON) even when the engine main body 2 is not in the normal operation (warm-up operation). Specifically, even under operating conditions other than the normal operation (warm-up operation) of the engine main body 2, the exhaust gas recirculation system 4 according to the embodiment circulates the EGR gas (EGR ON).

However, during normal operation (warm-up operation) of the engine main body 2, the exhaust gas recirculation system 4 operates in the cooling mode (bypass OFF) in which the EGR gas does not pass through the bypass path 44, and cools the EGR gas in the cooling unit 43. On the other hand, under operating conditions other than the normal operation (warm-up operation) of the engine main body 2, the exhaust gas recirculation system 4 operates in the bypass mode (bypass ON) in which the EGR gas passes through the bypass path 44, and does not cool the EGR gas in the cooling unit 43. Specifically, the exhaust gas recirculation system 4 circulates the EGR gas in the bypass mode in which the EGR gas is not cooled in the "low water temperature" state (cold state: low water temperature), the "continuous light-load operation (low exhaust gas temperature)" state, and the like in the normal operation of the engine main body 2. Also during regeneration of the emission control device 53 (DPF regeneration operation), the exhaust gas recirculation system 4 circulates the EGR gas in the bypass mode.

Further, when the stop condition is satisfied under the operating conditions other than the normal operation (warm-up operation) of the engine main body 2, the exhaust gas recirculation system 4 closes the EGR valve 42 to stop the recirculation of the EGR gas (EGR OFF). That is, the stop condition is satisfied when the temperature of the exhaust gas is extremely low and the temperature of the refrigerant is relatively low in the "low water temperature" state (cold state: low water temperature) and the "continuous light-load operation (low exhaust gas temperature)" state in the normal operation of the engine main body 2, so that the exhaust gas recirculation system 4 stops the circulation of the EGR gas. At the time of regeneration of the emission control device 53 (DPF regeneration operation), when the regeneration mode of the emission control device 53 is the active regeneration mode in which post injection is performed, the exhaust gas recirculation system 4 stops the circulation of the EGR gas on the assumption that the stop condition is satisfied.

Incidentally, (the cooling path 431 of) the cooling unit 43 and the bypass path 44 may be formed in at least one of the exhaust manifold 26 and the cylinder head 22, and the switching valve 45 may be mounted on at least one of the intake manifold 25 and the cylinder head 22. That is, the EGR path 41 branches into the cooling path 431 and the bypass path 44 from an upstream-side end to a downstream-side end in the flow direction of the EGR gas, and the switching valve 45 is located on the downstream side of the cooling path 431 and the bypass path 44. Here, in the cylinder head 22, the cooling path 431 is located on the side of a water jacket through which the refrigerant (cooling water) passes, and the bypass path 44 is located on the outer side. Further, a heat insulating layer such as an air layer is preferably interposed between the water jacket and the bypass path 44.

In this configuration, since the switching valve 45 is mounted on an intake side having a low ambient temperature, cooling of the switching valve 45 becomes unnecessary, and in the bypass mode, the EGR gas is kept warm by passing through the bypass path 44 in the cylinder head 22, which is a casting, and recirculated at a higher temperature. On the other hand, in the cooling mode, since the EGR gas is also cooled in the water jacket of the cylinder head 22 when passing through the cooling path 431, the EGR gas is recirculated at a lower temperature. Therefore, the EGR gas can be recirculated to the intake port 201 at a lower temperature in the cooling mode and at a higher temperature in the bypass mode, the EGR gas can be introduced in a wide range from a low temperature to a high temperature of the exhaust gas, and an exhaust component can be reduced.

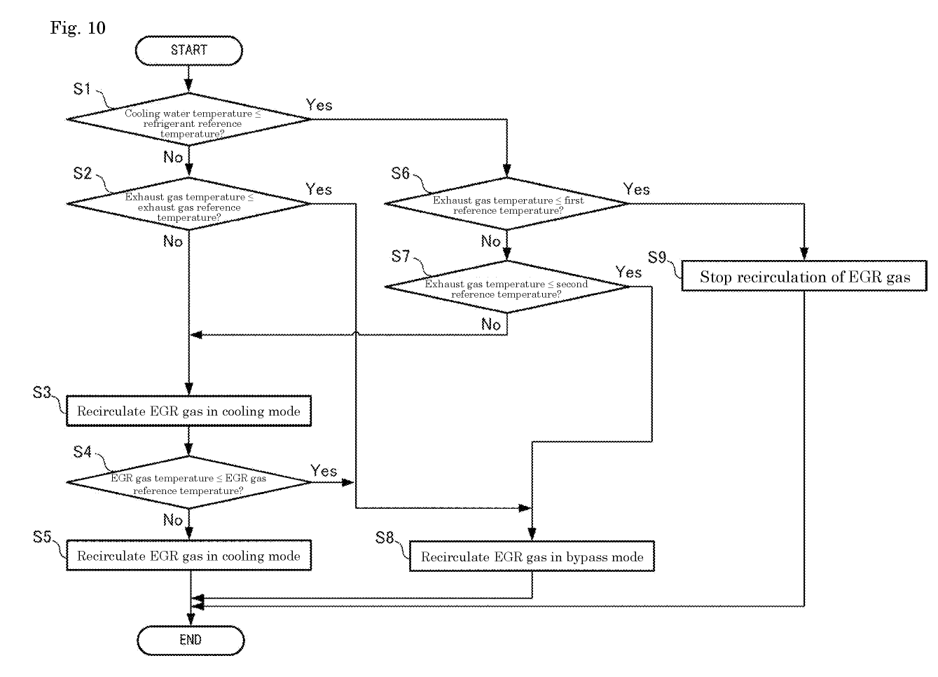

FIG. 10 is a flowchart illustrating an example of processing particularly related to the operation of the engine main body 2 during the normal operation in processing related to the control method of the exhaust gas recirculation system 4 executed by the control unit 11. Here, the first reference temperature is lower than the exhaust gas reference temperature, and the second reference temperature is higher than the exhaust gas reference temperature (first reference temperature < exhaust gas reference temperature < second reference temperature).

As illustrated in FIG. 10, the control unit 11 first determines whether the temperature of the refrigerant (cooling water temperature) is equal to or lower than the refrigerant reference temperature (S1). If the cooling water temperature is higher than the refrigerant reference temperature (S1: No), the control unit 11 determines whether the temperature of the exhaust gas (exhaust gas temperature) is equal to or lower than the exhaust gas reference temperature (S2). If the exhaust gas temperature is higher than the exhaust gas reference temperature (S2: No), the control unit 11 recirculates the EGR gas in the cooling mode (S3).

Then, the control unit 11 determines whether the flow of the EGR gas is stable (S4). When the state in which the temperature of the EGR gas is equal to or lower than the EGR gas reference temperature continues for a certain period of time (S4: Yes), the control unit 11 recirculates the EGR gas in the bypass mode (S8). If the state in which the temperature of the EGR gas is equal to or lower than the EGR gas reference temperature has not continued for a certain period of time (S4: No), the control unit 11 recirculates the EGR gas in the cooling mode (S5).

If the cooling water temperature is equal to or lower than the refrigerant reference temperature (S1: Yes), the control unit 11 determines whether the temperature of the exhaust gas (exhaust gas temperature) is equal to or lower than the first reference temperature (S6). If the exhaust gas temperature is higher than the first reference temperature (S6: No), the control unit 11 determines whether the temperature of the exhaust gas (exhaust gas temperature) is equal to or lower than the second reference temperature (S7). If the exhaust gas temperature is higher than the second reference temperature (S7: No), the control unit 11 shifts the processing to step S3 (recirculation of the EGR gas in the cooling mode).

On the other hand, if the exhaust gas temperature is equal to or lower than the second reference temperature (S7: Yes), the control unit 11 shifts the processing to step S8 (recirculation of the EGR gas in the bypass mode). If the exhaust gas temperature is equal to or lower than the first reference temperature (S6: Yes), the control unit 11 stops the recirculation of the EGR gas (S9).

The control unit 11 repeatedly executes the processing of steps S1 to S9 during normal operation of the engine main body 2. However, the flowchart illustrated in FIG. 10 is merely an example, and processing may be added or omitted as appropriate, or the order of processing may be changed as appropriate.

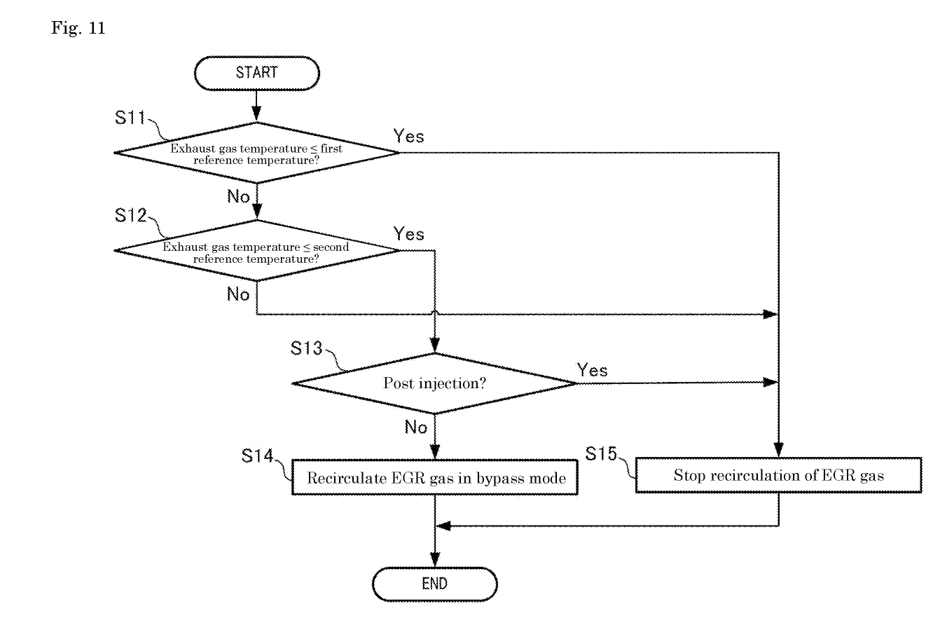

FIG. 11 is a flowchart illustrating an example of processing particularly related to the operation at the time of regeneration of the emission control device 53 in the processing related to the control method of the exhaust gas recirculation system 4 executed by the control unit 11. Here, the first reference temperature is lower than the second reference temperature (first reference temperature < second reference temperature).

As illustrated in FIG. 11, the control unit 11 first determines whether the temperature of the exhaust gas (exhaust gas temperature) is equal to or lower than the first reference temperature (S11). If the exhaust gas temperature is equal to or lower than the first reference temperature (S11: Yes), the control unit 11 stops the recirculation of the EGR gas (S15). If the exhaust gas temperature is higher than the first reference temperature (S11: No), the control unit 11 determines whether the temperature of the exhaust gas (exhaust gas temperature) is equal to or lower than the second reference temperature (S12). If the exhaust gas temperature is higher than the second reference temperature (S12: No), the control unit 11 stops the recirculation of the EGR gas (S15).

If the exhaust gas temperature is equal to or lower than the second reference temperature (S12: Yes), the control unit 11 determines whether post injection is performed in the regeneration of the emission control device 53 (S13). If the regeneration mode of the emission control device 53 is the active (forced) regeneration mode with post injection, the control unit 11 determines that post injection is performed (S13: Yes), and stops the recirculation of the EGR gas (S15).

On the other hand, if the regeneration mode of the emission control device 53 is the passive regeneration mode without post injection, the control unit 11 determines that post injection is not performed (S13: No), and recirculates the EGR gas in the bypass mode (S14).

The control unit 11 repeatedly executes the processing of steps S11 to S15 at the time of regeneration of the emission control device 53. However, the flowchart illustrated in FIG. 11 is merely an example, and processing may be added or omitted as appropriate, or the order of processing may be changed as appropriate.

### 3. Details of aftertreatment system

Next, details of the aftertreatment system 5 according to the embodiment will be described with reference to FIGS. 6 and 12 to 18.

As illustrated in FIG. 6, the aftertreatment system 5 includes, in addition to the first SCR device 51, the second SCR device 52, and the emission control device 53, a first ammonia slip catalyst (ASC) device 54, a second ASC device 55, a first reducing agent supply device 56, and a second reducing agent supply device 57. Here, the control unit 11 can control the aftertreatment system 5, specifically, the first reducing agent supply device 56 and the second reducing agent supply device 57, and thus is regarded as a component of the aftertreatment system 5.

These components of the aftertreatment system 5 are disposed on the exhaust path 28. In particular, the first SCR device 51, the first ASC device 54, the emission control device 53, the second SCR device 52, and the second ASC device 55 are connected in series in this order from the upstream side in the flow direction of the exhaust gas in the exhaust path 28. That is, the exhaust gas discharged from the engine main body 2 to the exhaust path 28 passes through the first SCR device 51, the first ASC device 54, the emission control device 53, the second SCR device 52, and the second ASC device 55 in this order. Further, the oxidation catalyst 531 and the soot filter 532 of the emission control device 53 are connected such that the oxidation catalyst 531 is located on the upstream side and the soot filter 532 is located on the downstream side in the flow direction of the exhaust gas in the exhaust path 28.

Therefore, the exhaust gas passing through the exhaust path 28 passes through the first SCR device 51, the first ASC device 54, the oxidation catalyst 531, the soot filter 532, the second SCR device 52, and the second ASC device 55 in this order. The aftertreatment system 5 includes a set of the first SCR device 51 and the first ASC device 54 on the upstream side (in the flow direction of the exhaust gas) and a set of the second SCR device 52 and the second ASC device 55 on the downstream side, with respect to the emission control device 53 (the oxidation catalyst 531 and the soot filter 532).

The first SCR device 51 and the first ASC device 54 are housed in a first SCR case 501, and the emission control device 53, the second SCR device 52, and the second ASC device 55 are housed in a second SCR case 502. Each of the first SCR case 501 and the second SCR case 502 is a substantially cylindrical case (housing) and is inserted into the exhaust path 28.

Specifically, the exhaust path 28 includes a connection path 71, an intermediate path 72, and a downstream path 73. The connection path 71 connects the exhaust port 202 and the first SCR case 501. The intermediate path 72 connects the first SCR case 501 and the second SCR case 502. The downstream path 73 is connected to the second SCR case 502 on the downstream side in the flow direction of the exhaust gas. That is, the connection path 71, the first SCR case 501, the intermediate path 72, the second SCR case 502, and the downstream path 73 are connected in series in this order from the upstream side in the flow direction of the exhaust gas.

In the first SCR case 501, the first SCR device 51 and the first ASC device 54 are connected in series and housed in this order from the upstream side (that is, the connection path 71 side) in the flow direction of the exhaust gas. In the second SCR case 502, the oxidation catalyst 531, the soot filter 532, the second SCR device 52, and the second ASC device 55 are connected in series and housed in this order from the upstream side (that is, the intermediate path 72 side) in the flow direction of the exhaust gas.

Here, the first reducing agent supply device 56 and the second reducing agent supply device 57 supply a reducing agent (urea water as an example in the embodiment) to the first SCR device 51 and the second SCR device 52, respectively. Specifically, the first reducing agent supply device 56 injects the reducing agent into the connection path 71 of the exhaust path 28 to supply the reducing agent to the first SCR device 51. The second reducing agent supply device 57 injects the reducing agent to a position between the soot filter 532 and the second SCR device 52 in the second SCR case 502 to supply the reducing agent to the second SCR device 52. The first reducing agent supply device 56 is also simply referred to as a "reducing agent supply device 56".

As described above, the first reducing agent supply device 56 is located on the upstream side of the first SCR device 51 in the flow direction of the exhaust gas. The first reducing agent supply device 56 injects urea water as a reducing agent into the exhaust path 28, and the first SCR device 51 reduces nitrogen oxides in the exhaust gas to nitrogen by ammonia gas generated by hydrolysis of the urea water by exhaust heat of the engine main body 2. The second reducing agent supply device 57 is located on the upstream side of the second SCR device 52 in the flow direction of the exhaust gas. The second reducing agent supply device 57 injects urea water as a reducing agent into the exhaust path 28, and the second SCR device 52 reduces nitrogen oxides in the exhaust gas to nitrogen by ammonia gas generated by hydrolysis of the urea water by exhaust heat of the engine main body 2.

As described above, the aftertreatment system 5 according to the embodiment is a double dosing system in which two SCRs (the first SCR device 51 and the second SCR device 52) are disposed in series and a reducing agent (urea water) is supplied to each of the two SCRs. Therefore, the aftertreatment system 5 efficiently decomposes nitrogen oxides depending on the situation, for example, mainly operates the first SCR device 51 close to the engine main body 2 under a light load with a low temperature of exhaust gas, and mainly operates the second SCR device 52 under a heavy load with a high temperature of exhaust gas. Accordingly, the aftertreatment system 5 can significantly reduce nitrogen oxides in the exhaust gas.

The carrier of the first SCR device 51 and the carrier of the second SCR device 52 may be the same or different. As the carrier, metal (for example, stainless steel), ceramics (for example, silicon carbide or cordierite), or the like can be used. Each of the first SCR device 51 and the second SCR device 52 converts nitrogen oxides (NOx) in the exhaust gas into nitrogen molecules (N₂) and water (H₂O) by a catalyst, thereby reducing the nitrogen oxides in the exhaust gas.

Moreover, each of the first ASC device 54 and the second ASC device 55 is an example of a decomposition catalyst, and is a catalyst that oxidizes and decomposes ammonia that has not been consumed by the first SCR device 51 and the second SCR device 52. Accordingly, it is possible to prevent ammonia from being discharged into the atmosphere.

Moreover, the emission control device 53 decomposes particulate matter in the exhaust gas by the oxidation catalyst 531 and collects the particulate matter by the soot filter 532. Here, since the particulate matter captured by the soot filter 532 causes clogging of the soot filter 532 as it is, it is necessary to regenerate the soot filter 532 in the emission control device 53.

As described above, the regeneration mode of the emission control device 53 includes the active (forced) regeneration mode in which post injection is performed and the passive regeneration mode in which post injection is not performed. In the active regeneration mode, unburned fuel is sent to the oxidation catalyst 531 by post injection in which fuel is injected later than a main combustion injection timing to forcibly raise the temperature of the exhaust gas, and particulate matter accumulated on the soot filter 532 is burned. In the passive regeneration mode, regeneration called a "continuous regeneration method" or a "self-regeneration method" is performed using an oxidation action by a catalyst, instead of using heat from an external heat source.

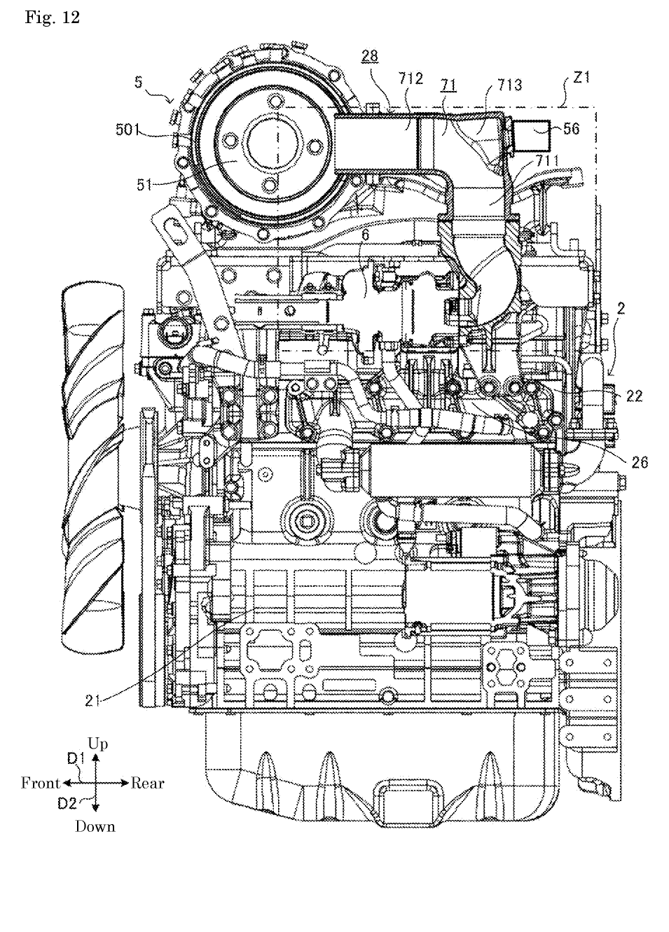

The aftertreatment system 5 according to the embodiment includes the emission control device 53, the (first) SCR device 51, and the connection path 71. The emission control device 53 captures the particulate matter in the exhaust gas discharged from the engine main body 2. The SCR device 51 is located between the exhaust port 202 of the engine main body 2 and the emission control device 53. The connection path 71 connects the exhaust port 202 and the SCR device 51. Here, as illustrated in FIGS. 12 to 14, the connection path 71 includes a first path 711, a second path 712, and a coupling portion 713. The first path 711 and the second path 712 have lengths in directions intersecting each other. The coupling portion 713 couples the first path 711 and the second path 712.

That is, in the exhaust path 28, the connection path 71 located between the exhaust port 202 and the (first) SCR device 51 is not straight, but includes the first path 711 and the second path 712 having the lengths in the directions intersecting each other. The coupling portion 713 coupling the first path 711 and the second path 712 is a bent portion (including a bending portion and a curved portion).

Accordingly, a wall surface (pipe wall) temperature of the connection path 71 easily rises due to heat (exhaust heat) of the exhaust gas on the upstream side (the exhaust port 202 side) in the flow direction of the exhaust gas as viewed from the SCR device 51. As a result, even when the connection path 71 from the exhaust port 202 of the engine main body 2 to the SCR device 51 is shortened, the reducing agent is easily decomposed sufficiently, and exhaust gas purification performance in the SCR device 51 is less likely to deteriorate. Moreover, when the connection path 71 is shortened, the SCR device 51 can be raised in temperature at an early stage after the start of the engine main body 2, for example, as compared with a case where the connection path 71 is lengthened, so that the time required for the SCR device 51 to reach an activation temperature can be shortened. Therefore, the exhaust gas purification performance immediately after the start of the engine main body 2 is less likely to deteriorate.

In short, the coupling portion 713 of the connection path 71 is a portion that changes the passing direction of the exhaust gas from a first direction (the longitudinal direction of the first path 711) to a second direction (the longitudinal direction of the second path 712) intersecting with each other. In the embodiment, as an example, the first direction (the longitudinal direction of the first path 711) is the up-down direction D2, and the second direction (the longitudinal direction of the second path 712) is the output shaft direction D1, as illustrated in FIGS. 12 to 14. That is, the exhaust gas passing through the connection path 71 passes through the first path 711 along the up-down direction D2 (from the lower side to the upper side), and passes through the second path 712 along the output shaft direction D1 (from the rear side to the front side) after the passing direction is changed by the coupling portion 713. At this time, since the exhaust gas collides with the wall surface (pipe wall) of the connection path 71, the wall surface (pipe wall) temperature of the connection path 71 easily rises.

Moreover, for example, it is also conceivable to shorten the connection path 71 by disposing a mixer, an evaporation plate, or the like immediately before the SCR device 51. However, in this case, there is a possibility that the fuel efficiency deteriorates due to an increase in pressure loss, and there is also a risk of breakage, which leads to a decrease in the reliability of the aftertreatment system 5. On the other hand, in the embodiment, since the connection path 71 can be shortened without providing a mixer, an evaporation plate, or the like, the occurrence of such a problem can also be suppressed.

In the embodiment, the supercharger 6 is further disposed on the upstream side (the exhaust port 202 side) in the flow direction of the exhaust gas as viewed from the connection path 71. Therefore, the exhaust gas having passed through the supercharger 6 is introduced into the connection path 71. Here, as illustrated in FIG. 12, the supercharger 6 is located in front of the first path 711, and the exhaust gas passing through the supercharger 6 from the front side to the rear side passes through the first path 711 from the lower side to the upper side, then passes through the second path 712 from the rear side to the front side, and is introduced into the SCR device 51. By disposing the connection path 71 immediately after the supercharger 6 in this manner, the exhaust gas easily hits the wall surface (pipe wall) of the connection path 71, and the wall surface temperature easily rises.

Here, the connection path 71 further includes a linear portion that has a linear shape, is located between the coupling portion 713 and the SCR device 51, and allows the exhaust gas to pass through the linear portion. In the embodiment, since the second path 712 having a length in the output shaft direction D1 is linear, the second path 712 is an example of the linear portion. With such a linear portion (second path 712), the exhaust gas having passed through the coupling portion 713 can smoothly flow toward the SCR device 51.

Moreover, the aftertreatment system 5 according to the embodiment further includes the (first) reducing agent supply device 56 that supplies a reducing agent to the inside of the coupling portion 713. That is, the reducing agent is supplied from the reducing agent supply device 56 into the coupling portion 713 on the upstream side in the flow direction of the exhaust gas as viewed from the SCR device 51.

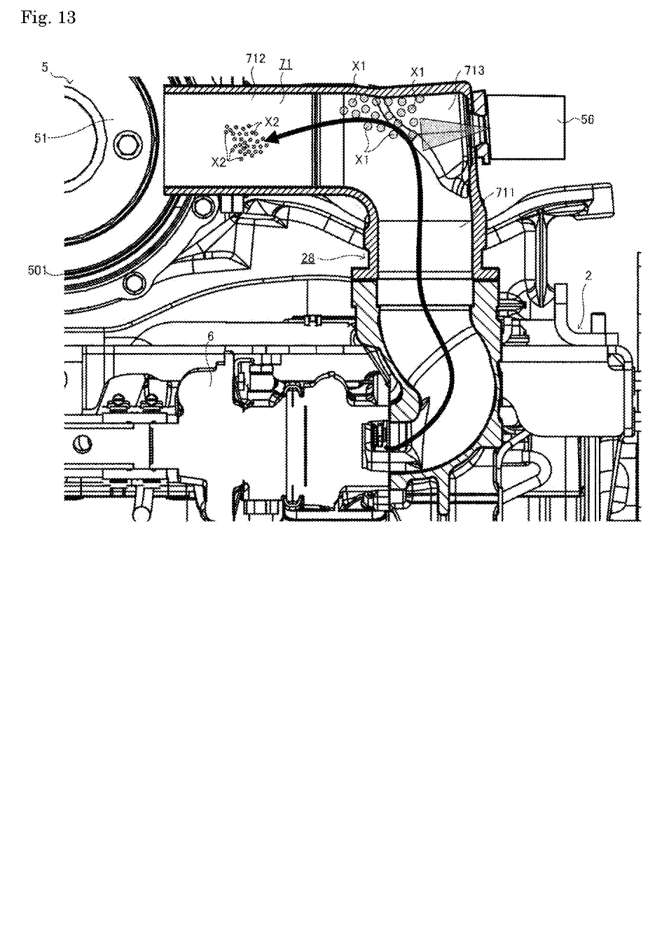

Specifically, as illustrated in FIG. 13, the reducing agent supply device 56 is disposed outside the coupling portion 713 in the connection path 71, and injects the reducing agent (urea water) into the coupling portion 713 through a hole formed in the connection path 71. FIG. 13 is an enlarged view of a region Z1 in FIG. 12, and schematically illustrates the flow of exhaust gas by the thick arrow. Further, FIG. 13 schematically illustrates droplets X1 of the reducing agent (urea water) and an ammonia gas X2.

That is, when the reducing agent supply device 56 injects the reducing agent into the coupling portion 713 in the connection path 71, the droplet X1 of the reducing agent easily hits the wall surface (pipe wall) of the coupling portion 713 heated by the exhaust gas. As a result, the decomposition of the reducing agent is promoted, which promotes the generation of the ammonia gas X2.

Moreover, the reducing agent supply device 56 injects the reducing agent toward the downstream side in the flow direction of the exhaust gas. In the embodiment, the reducing agent supply device 56 injects the reducing agent toward the SCR device 51 side, which is the downstream side in the flow direction of the exhaust gas in the coupling portion 713. Accordingly, the droplet X1 of the reducing agent and the ammonia gas X2 can be carried on the exhaust gas toward the SCR device 51 side, and the reducing agent can be easily supplied to the SCR device 51.

The connection path 71 includes a stirring portion that stirs exhaust gas at the coupling portion 713. In the embodiment, the wall surface (pipe wall) of the coupling portion 713 functions as the stirring portion that stirs exhaust gas. Accordingly, the exhaust gas actively heats the wall surface (pipe wall) of the coupling portion 713, and the temperature of the wall surface (pipe wall) of the coupling portion 713 easily rises.

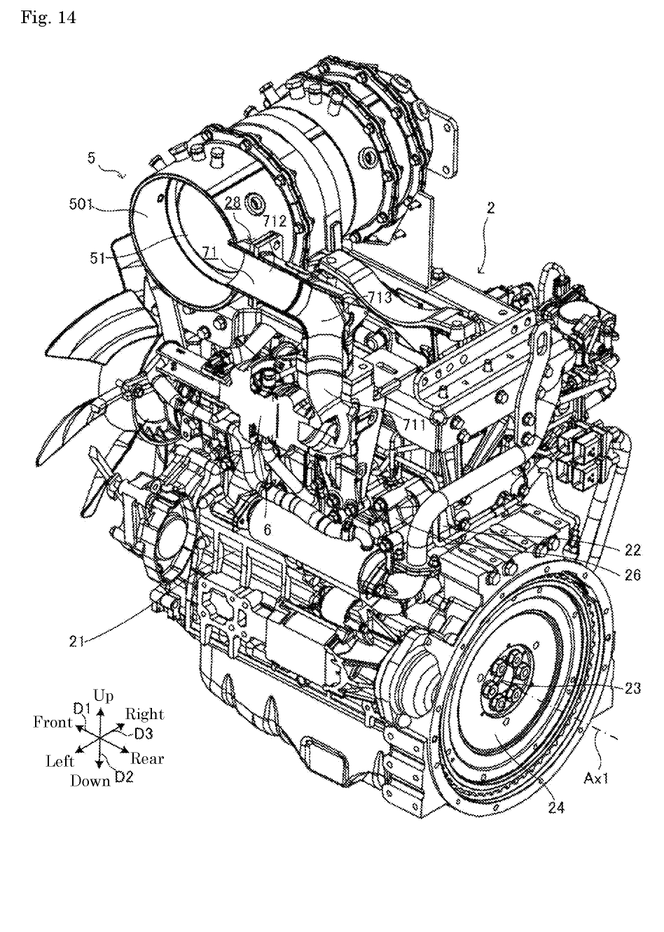

Moreover, in the embodiment, as illustrated in FIG. 14, the connection path 71 is connected to the SCR device 51 from a direction intersecting the passing direction of the exhaust gas in the SCR device 51. Here, the passing direction of the exhaust gas in the SCR device 51 is the width direction D3 (from the left side to the right side), and the connection path 71 is connected to the SCR device 51 from (behind) the output shaft direction D1 intersecting (orthogonal to) the width direction D3. Accordingly, the reducing agent (ammonia gas X2) introduced from the connection path 71 into the SCR device 51 easily acts on the SCR device 51.

Further, the connection path 71 discharges the exhaust gas introduced from one side to the one side. In the embodiment, the exhaust gas is introduced into (the first path 711 of) the connection path 71 from the front side in the output shaft direction D1, and the exhaust gas is discharged from (the second path 712 of) the connection path 71 to the front side in the output shaft direction D1. Accordingly, the exhaust gas easily hits the wall surface (pipe wall) of the connection path 71, and the wall surface temperature easily rises.

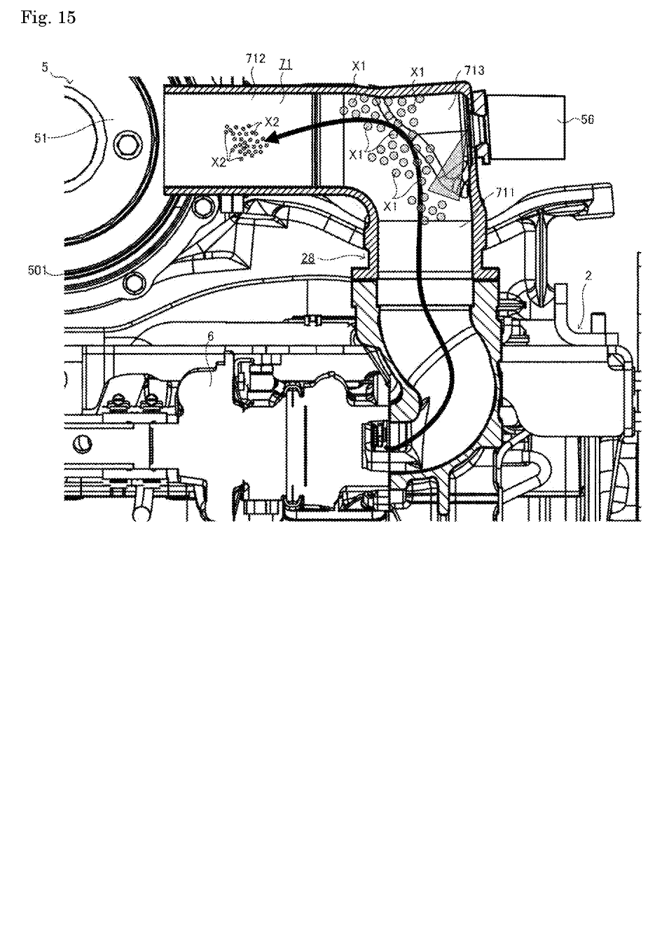

Moreover, as illustrated in FIG. 15, the reducing agent supply device 56 may inject the reducing agent toward the upstream side in the flow direction of the exhaust gas in the coupling portion 713. That is, the reducing agent supply device 56 injects the reducing agent toward the first path 711 side, which is the upstream side in the flow direction of the exhaust gas in the coupling portion 713. Accordingly, the droplet X1 of the reducing agent and the ammonia gas X2 can be carried on the exhaust gas toward the SCR device 51 side, and the reducing agent can be easily supplied to the SCR device 51.

The aftertreatment system 5 according to the embodiment includes the first SCR device 51, the second SCR device 52, the first reducing agent supply device 56, the second reducing agent supply device 57, and the control unit 11. The first SCR device 51 is located on the exhaust path 28 through which the exhaust gas discharged from the engine main body 2 passes. The second SCR device 52 is located on the exhaust path 28 and on the downstream side of the first SCR device 51 in the flow direction of the exhaust gas. The first reducing agent supply device 56 supplies the reducing agent to the first SCR device 51. The second reducing agent supply device 57 supplies the reducing agent to the second SCR device 52. The control unit 11 individually controls the supply amount of the reducing agent of each of the first reducing agent supply device 56 and the second reducing agent supply device 57.

That is, the control method of the aftertreatment system 5 according to the embodiment can be regarded as a control method of the aftertreatment system 5 including the first SCR device 51, the second SCR device 52, the first reducing agent supply device 56, and the second reducing agent supply device 57. This control method includes individually controlling the supply amount of the reducing agent of each of the first reducing agent supply device 56 and the second reducing agent supply device 57.

In short, in the double dosing aftertreatment system 5 configured to supply the reducing agent (urea water) to each of the first SCR device 51 and the second SCR device 52, the supply amount of the reducing agent to the first SCR device 51 and the second SCR device 52 is individually controlled. For example, in order to perform passive regeneration (self-regeneration) of the emission control device 53, it is necessary to supply nitrogen dioxide (NO₂) obtained by oxidizing nitrogen monoxide (NO) flowing into the emission control device 53 to the soot filter 532. In the aftertreatment system 5 according to the embodiment, the supply amount of the reducing agent can be limited only for the first reducing agent supply device 56 or only for the second reducing agent supply device 57 as necessary to adjust nitrogen oxide purification capability in each of the first SCR device 51 and the second SCR device 52.

Therefore, according to the aftertreatment system 5, for example, by suppressing nitrogen monoxide purification capability only for the first SCR device 51 located on the upstream side of the emission control device 53, it is possible to maintain the amount of nitrogen monoxide flowing into the emission control device 53 and ensure the regeneration capability of the emission control device 53. As a result, the aftertreatment system 5 according to the embodiment has an advantage that the exhaust gas purification performance is less likely to deteriorate.

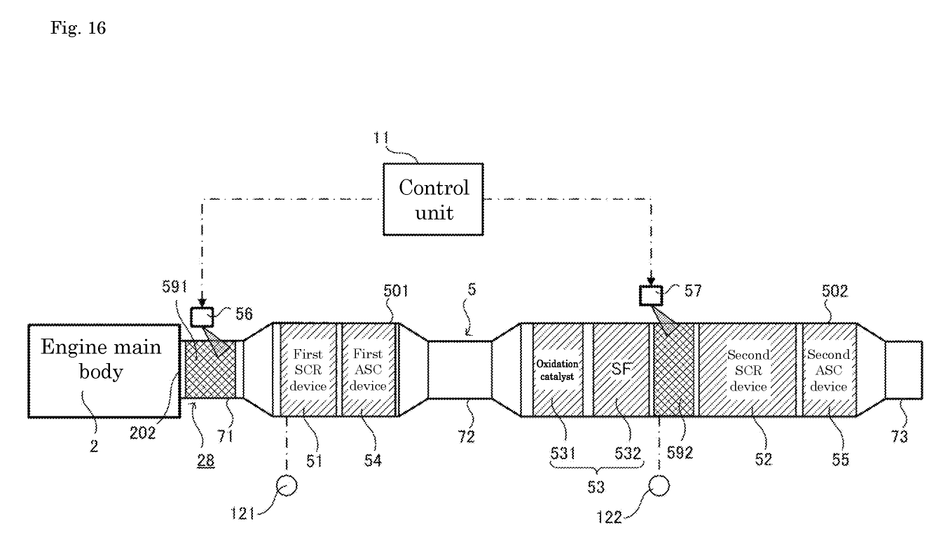

Specifically, as illustrated in FIG. 16, the aftertreatment system 5 individually controls each of the first reducing agent supply device 56 and the second reducing agent supply device 57 with the control unit 11. Here, the control unit 11 can control the supply amount (injection amount) of the reducing agent of each of the first reducing agent supply device 56 and the second reducing agent supply device 57 in a range of 0% to 100%.

Moreover, in the example of FIG. 16, the aftertreatment system 5 includes a first mixer 591 and a second mixer 592. The first mixer 591 is disposed immediately before (on the upstream side of) the first SCR device 51, and the second mixer 592 is disposed immediately before (on the upstream side of) the second SCR device 52. However, the first mixer 591 and the second mixer 592 are not essential, and can be appropriately omitted.

More specifically, in the embodiment, the aftertreatment system 5 includes the emission control device 53 that captures particulate matter in the exhaust gas. The emission control device 53 is located between the first SCR device 51 and the second SCR device 52 in the exhaust path 28. The control unit 11 controls the supply amount of the reducing agent of each of the first reducing agent supply device 56 and the second reducing agent supply device 57 such that the regeneration capability of the emission control device 53 is equal to or greater than a predetermined value.

As described above, by adjusting the supply amount of the reducing agent of each of the first reducing agent supply device 56 and the second reducing agent supply device 57 using the regeneration capability of the emission control device 53 as an index, it is easy to maintain the amount of nitrogen monoxide flowing into the emission control device 53 and ensure the regeneration capability of the emission control device 53. As a result, according to the aftertreatment system 5 according to the embodiment, the exhaust gas purification performance is less likely to deteriorate.

Here, the control unit 11 controls the supply amount of the reducing agent of each of the first reducing agent supply device 56 and the second reducing agent supply device 57 depending on whether the regeneration mode of the emission control device 53 is the passive regeneration mode or the active regeneration mode. That is, as described above, when the emission control device 53 performs regeneration in the passive regeneration mode, nitrogen dioxide (NO₂) obtained by oxidizing nitrogen monoxide (NO) flowing into the emission control device 53 needs to be supplied to the soot filter 532. On the other hand, in the active regeneration mode, oxygen (O₂) in the exhaust gas is supplied to the soot filter 532 by performing post injection to burn the particulate matter. Therefore, in the active regeneration mode, there is no need to supply nitrogen dioxide to the soot filter 532.

Then, since the supply amount of the reducing agent of each of the first reducing agent supply device 56 and the second reducing agent supply device 57 is controlled depending on whether the regeneration mode of the emission control device 53 is the passive regeneration mode or the active regeneration mode, the purification capability of the first SCR device 51 is not lowered more than necessary. In short, in the passive regeneration mode, for example, the amount of nitrogen monoxide flowing into the emission control device 53 can be maintained by suppressing the supply amount of the reducing agent of the first reducing agent supply device 56 to be small and suppressing the nitrogen oxide purification capability in the first SCR device 51 to be low. On the other hand, in the active regeneration mode, for example, the supply amount of the reducing agent of the first reducing agent supply device 56 can be increased to increase the nitrogen oxide purification capability in the first SCR device 51. In either case, it is easy to ensure the regeneration capability of the emission control device 53.

Moreover, in the embodiment, the control unit 11 controls the supply amount of the reducing agent of each of the first reducing agent supply device 56 and the second reducing agent supply device 57 according to the catalyst temperature of each of the first SCR device 51 and the second SCR device 52. For example, when the catalyst temperature of the first SCR device 51 is low, the first SCR device 51 cannot be expected to have sufficient nitrogen oxide purification capability, and thus, the control unit 11 suppresses the supply amount of the reducing agent to the first SCR device 51 by the first reducing agent supply device 56 to be small. Similarly, for example, when the catalyst temperature of the second SCR device 52 is low, the second SCR device 52 cannot be expected to have sufficient nitrogen oxide purification capability, and thus, the control unit 11 suppresses the supply amount of the reducing agent to the second SCR device 52 by the second reducing agent supply device 57 to be small. Accordingly, consumption of the reducing agent can be suppressed.

Specifically, as illustrated in FIG. 16, the aftertreatment system 5 includes a first temperature sensor 121 and a second temperature sensor 122 included in the sensor 12. The first temperature sensor 121 measures the catalyst temperature of the first SCR device 51, and the second temperature sensor 122 measures the catalyst temperature of the second SCR device 52. The measurement results of the first temperature sensor 121 and the second temperature sensor 122 are output to the control unit 11. The control unit 11 controls the supply amount of the reducing agent of each of the first reducing agent supply device 56 and the second reducing agent supply device 57 based on the measurement results of the first temperature sensor 121 and the second temperature sensor 122.

In the embodiment, particularly, when the catalyst temperatures of both the first SCR device 51 and the second SCR device 52 are equal to or higher than the activation temperature and the emission control device 53 is performing regeneration in the active regeneration mode, the control unit 11 makes the supply amount of the reducing agent of the first reducing agent supply device 56 larger than the supply amount of the reducing agent of the second reducing agent supply device 57. That is, even in a state in which both the first SCR device 51 and the second SCR device 52 can purify nitrogen oxides, when the emission control device 53 is performing regeneration in the active regeneration mode, the purification of nitrogen oxides is mainly performed by the first SCR device 51 instead of the second SCR device 52. That is, in the active regeneration mode in which there is no need to introduce nitrogen monoxide into the emission control device 53, the nitrogen oxide purification capability of the first SCR device 51 can be made higher than the nitrogen oxide purification capability of the second SCR device 52 to ensure sufficient nitrogen oxide purification capability.

Further, when the catalyst temperatures of both the first SCR device 51 and the second SCR device 52 are equal to or higher than the activation temperature, the control unit 11 controls the supply amount of the reducing agent of each of the first reducing agent supply device 56 and the second reducing agent supply device 57 according to an inlet temperature of the emission control device 53. The inlet temperature of the emission control device 53 is detected based on, for example, the temperature of the exhaust gas passing through the intermediate path 72 measured by a temperature sensor included in the sensor 12.

When the inlet temperature of the emission control device 53 is too high, the amount of nitrogen dioxide generated from nitrogen monoxide flowing into the emission control device 53 decreases, so that sufficient regeneration capability of the emission control device 53 cannot be expected. Therefore, for example, when the inlet temperature of the emission control device 53 is equal to or higher than a predetermined temperature, the supply amount of the reducing agent of the first reducing agent supply device 56 can be increased to increase the nitrogen oxide purification capability of the first SCR device 51.

Specifically, when the catalyst temperatures of both the first SCR device 51 and the second SCR device 52 are equal to or higher than the activation temperature and the inlet temperature of the emission control device 53 is equal to or higher than the predetermined temperature, the control unit 11 makes the supply amount of the reducing agent of the first reducing agent supply device 56 larger than the supply amount of the reducing agent of the second reducing agent supply device 57. That is, even in the state in which both the first SCR device 51 and the second SCR device 52 can purify nitrogen oxides, when the generated amount of nitrogen dioxides decreases, the purification of nitrogen oxides is mainly performed by the first SCR device 51 instead of the second SCR device 52. That is, in a state in which the emission control device 53 cannot be expected to have sufficient regeneration capability, the nitrogen oxide purification capability of the first SCR device 51 can be made higher than the nitrogen oxide purification capability of the second SCR device 52 to ensure sufficient nitrogen oxide purification capability.

Moreover, when the catalyst temperatures of both the first SCR device 51 and the second SCR device 52 are equal to or higher than the activation temperature and the inlet temperature of the emission control device 53 is lower than the predetermined temperature, the control unit 11 makes the supply amount of the reducing agent of the second reducing agent supply device 57 larger than the supply amount of the reducing agent of the first reducing agent supply device 56. That is, in the state in which both the first SCR device 51 and the second SCR device 52 can purify nitrogen oxides and when nitrogen dioxide is sufficiently generated, the purification of nitrogen oxides is mainly performed by the second SCR device 52 instead of the first SCR device 51. That is, in a state in which sufficient regeneration capability is expected in the emission control device 53, the nitrogen oxide purification capability of the first SCR device 51 can be suppressed to be lower than the nitrogen oxide purification capability of the second SCR device 52 to maintain the amount of nitrogen monoxide flowing into the emission control device 53.

Moreover, when the catalyst temperature of only the first SCR device 51 of the first SCR device 51 and the second SCR device 52 is equal to or higher than the activation temperature, the control unit 11 causes only the first reducing agent supply device 56 of the first reducing agent supply device 56 and the second reducing agent supply device 57 to supply the reducing agent. That is, when the catalyst temperature of the second SCR device 52 is lower than the activation temperature, the second SCR device 52 cannot be expected to have sufficient nitrogen oxide purification capability, and thus, the control unit 11 stops the supply of the reducing agent to the second SCR device 52 by the second reducing agent supply device 57. Accordingly, consumption of the reducing agent can be suppressed.

Moreover, when the catalyst temperature of only the second SCR device 52 of the first SCR device 51 and the second SCR device 52 is equal to or higher than the activation temperature, the control unit 11 causes only the second reducing agent supply device 57 of the first reducing agent supply device 56 and the second reducing agent supply device 57 to supply the reducing agent. That is, when the catalyst temperature of the first SCR device 51 is lower than the activation temperature, the first SCR device 51 cannot be expected to have sufficient nitrogen oxide purification capability, and thus, the control unit 11 stops the supply of the reducing agent to the first SCR device 51 by the first reducing agent supply device 56. Accordingly, consumption of the reducing agent can be suppressed.

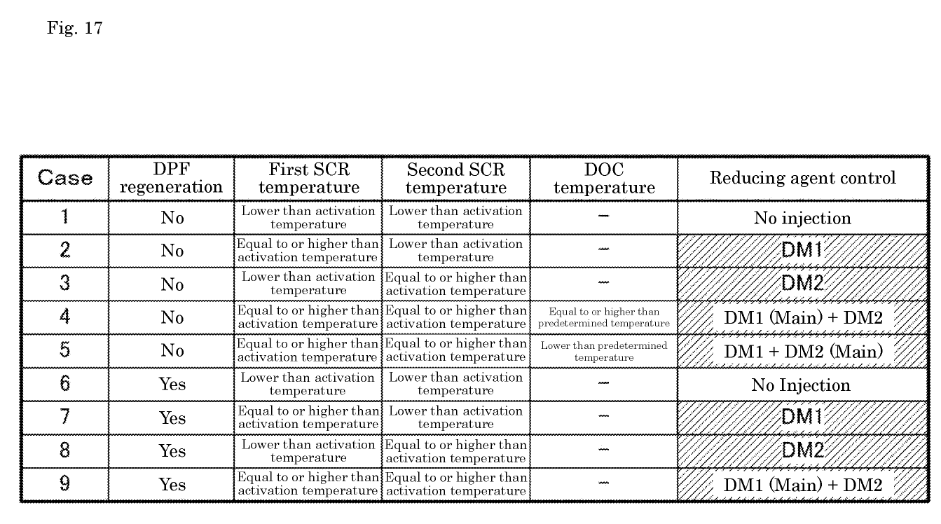

FIG. 17 illustrates operations of the aftertreatment system 5 according to the embodiment in various situations. In FIG. 17, "DM" is an abbreviation of "Dosing Module", "DM1" indicates the first reducing agent supply device 56, and "DM2" indicates the second reducing agent supply device 57.

First, "Case 1" to "Case 5" in which the emission control device 53 is not performing regeneration (DPF regeneration: no) will be described. In "Case 1" in which the catalyst temperatures of both the first SCR device 51 and the second SCR device 52 are lower than the activation temperature, both the first reducing agent supply device 56 and the second reducing agent supply device 57 stop the supply of the reducing agent (reducing agent control: no injection).

In "Case 2" in which only the catalyst temperature of the first SCR device 51 is equal to or higher than the activation temperature, only the first reducing agent supply device 56 supplies the reducing agent (reducing agent control: DM1), and the first SCR device 51 purifies nitrogen oxides. In "Case 3" in which only the catalyst temperature of the second SCR device 52 is equal to or higher than the activation temperature, only the second reducing agent supply device 57 supplies the reducing agent (reducing agent control: DM2), and the second SCR device 52 purifies nitrogen oxides.

In "Case 4" and "Case 5" in which the catalyst temperatures of the first SCR device 51 and the second SCR device 52 are equal to or higher than the activation temperature, the operation varies depending on the inlet temperature (DOC temperature) of the emission control device 53. That is, in "Case 4" in which the inlet temperature of the emission control device 53 is equal to or higher than the predetermined temperature, the supply amount of the reducing agent of the first reducing agent supply device 56 is larger than the supply amount of the reducing agent of the second reducing agent supply device 57 (reducing agent control: DM1 (main) + DM2), and the first SCR device 51 mainly purifies nitrogen oxides. In "Case 5" in which the inlet temperature of the emission control device 53 is lower than the predetermined temperature, the supply amount of the reducing agent of the second reducing agent supply device 57 is larger than the supply amount of the reducing agent of the first reducing agent supply device 56 (reducing agent control: DM1 + DM2 (main)), and the second SCR device 52 mainly purifies nitrogen oxides.

Next, "Case 6" to "Case 9" in which the emission control device 53 is performing regeneration (DPF regeneration: yes) will be described. In "Case 6" in which the catalyst temperatures of both the first SCR device 51 and the second SCR device 52 are lower than the activation temperature, both the first reducing agent supply device 56 and the second reducing agent supply device 57 stop the supply of the reducing agent (reducing agent control: no injection).

In "Case 7" in which only the catalyst temperature of the first SCR device 51 is equal to or higher than the activation temperature, only the first reducing agent supply device 56 supplies the reducing agent (reducing agent control: DM1), and the first SCR device 51 purifies nitrogen oxides. In "Case 8" in which only the catalyst temperature of the second SCR device 52 is equal to or higher than the activation temperature, only the second reducing agent supply device 57 supplies the reducing agent (reducing agent control: DM2), and the second SCR device 52 purifies nitrogen oxides.

In "Case 9" in which the catalyst temperatures of the first SCR device 51 and the second SCR device 52 are equal to or higher than the activation temperature, the same operation as in "Case 4" is performed regardless of the inlet temperature of the emission control device 53. That is, in "Case 9", the supply amount of the reducing agent of the first reducing agent supply device 56 is larger than the supply amount of the reducing agent of the second reducing agent supply device 57 (reducing agent control: DM1 (main) + DM2), and the first SCR device 51 mainly purifies nitrogen oxides.

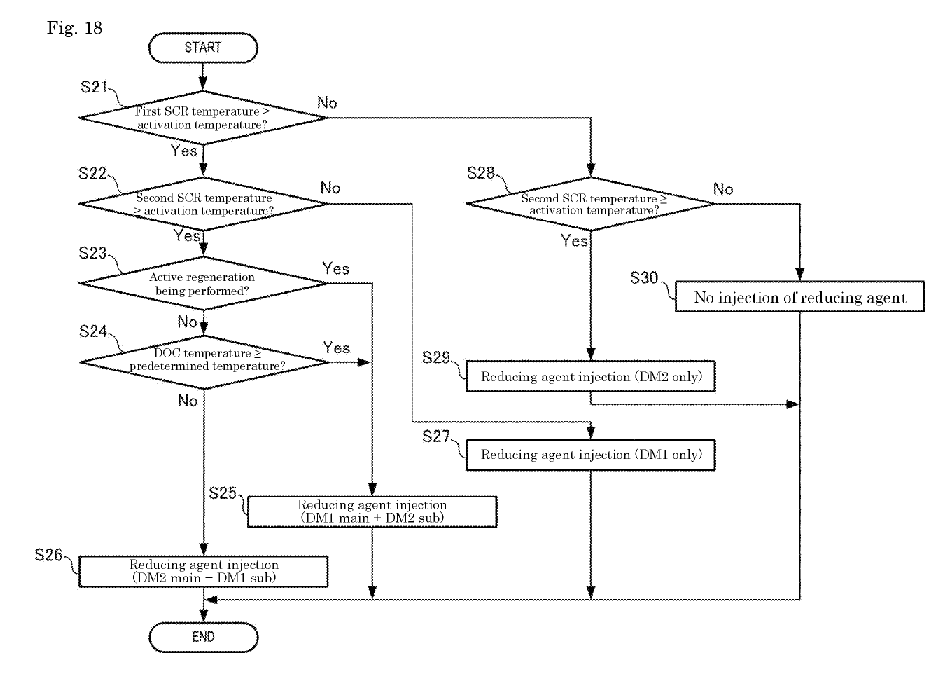

FIG. 18 is a flowchart illustrating an example of processing related to the control method of the aftertreatment system 5 executed by the control unit 11.

As illustrated in FIG. 18, the control unit 11 first determines whether the catalyst temperature of the first SCR device 51 is equal to or higher than the activation temperature (S21). If the catalyst temperature of the first SCR device 51 is equal to or higher than the activation temperature (S21: Yes), the control unit 11 determines whether the catalyst temperature of the second SCR device 52 is equal to or higher than the activation temperature (S22). Here, if the catalyst temperature of the second SCR device 52 is lower than the activation temperature (S22: No), the control unit 11 causes only the first reducing agent supply device 56 to supply the reducing agent (S27).

On the other hand, also when the catalyst temperature of the first SCR device 51 is lower than the activation temperature (S21: No), the control unit 11 determines whether the catalyst temperature of the second SCR device 52 is equal to or higher than the activation temperature (S28). Here, if the catalyst temperature of the second SCR device 52 is equal to or higher than the activation temperature (S28: Yes), the control unit 11 causes only the second reducing agent supply device 57 to supply the reducing agent (S29). If the catalyst temperature of the second SCR device 52 is lower than the activation temperature (S28: No), the control unit 11 causes neither the first reducing agent supply device 56 nor the second reducing agent supply device 57 to supply the reducing agent (S30).

In step S22, if the catalyst temperature of the second SCR device 52 is equal to or higher than the activation temperature (S22: Yes), the control unit 11 determines whether the emission control device 53 is performing regeneration in the active regeneration mode (S23). If the emission control device 53 is performing regeneration in the active regeneration mode (S23: Yes), the control unit 11 makes the supply amount of the reducing agent of the first reducing agent supply device 56 larger than the supply amount of the reducing agent of the second reducing agent supply device 57 (S25). Accordingly, the first SCR device 51 actively purifies nitrogen oxides.

If the emission control device 53 is not performing regeneration in the active regeneration mode (S23: No), the control unit 11 determines whether the inlet temperature of the emission control device 53 is equal to or higher than the predetermined temperature (S24). If the inlet temperature of the emission control device 53 is equal to or higher than the predetermined temperature (S24: Yes), the control unit 11 makes the supply amount of the reducing agent of the first reducing agent supply device 56 larger than the supply amount of the reducing agent of the second reducing agent supply device 57 (S25). If the inlet temperature of the emission control device 53 is lower than the predetermined temperature (S24: No), the control unit 11 makes the supply amount of the reducing agent of the second reducing agent supply device 57 larger than the supply amount of the reducing agent of the first reducing agent supply device 56 (S26). Accordingly, the first SCR device 51 passively purifies nitrogen oxides.

More specifically, in step S26, the control unit 11 calculates the target value of the overall purification rate of the first SCR device 51 and the second SCR device 52 based on the catalyst temperatures of the first SCR device 51 and the second SCR device 52, the flow rate of exhaust gas, an ammonia adsorption amount, an inflow amount of nitrogen oxides, and the like. Further, the control unit 11 calculates the maximum possible purification rate of the second SCR device 52, subtracts the purification rate of the second SCR device 52 from the target value of the overall purification rate, and compensates the difference with the purification rate of the first SCR device 51. That is, a value obtained by subtracting the purification rate of the second SCR device 52 from the target value of the overall purification rate is the purification rate of the first SCR device 51. The control unit 11 determines the supply amount of the reducing agent of the first reducing agent supply device 56 so as not to exceed the purification rate of the first SCR device 51 calculated in this manner. When the purification rate of the first SCR device 51 obtained at this time is “0%”, the control unit 11 stops the supply of the reducing agent by the first reducing agent supply device 56.

The control unit 11 repeatedly executes the processing of steps S21 to S30. However, the flowchart illustrated in FIG. 18 is merely an example, and processing may be added or omitted as appropriate, or the order of processing may be changed as appropriate.

Incidentally, in the aftertreatment system 5 according to the embodiment, deposits may be generated in which urea water as a reducing agent injected into the exhaust path 28 is precipitated as a solid substance. When the deposits are accumulated in the exhaust path 28, there is a risk such as a pressure loss. In the second SCR device 52, since the oxidation catalyst 531 is disposed on the upstream side in the flow direction of the exhaust gas, it is possible to remove the deposits by burning fuel with the oxidation catalyst 531 and decomposing and evaporating the deposits with high-temperature exhaust gas. On the other hand, in the first SCR device 51, since the oxidation catalyst 531 cannot be disposed on the upstream side in the flow direction of the exhaust gas, it is difficult to remove the deposits.

Therefore, in the embodiment, in order to suppress the generation of deposits in the first SCR device 51 in the first place, the control unit 11 determines the upper limit value of the supply amount of the reducing agent of the first reducing agent supply device 56 according to the temperature and flow rate of the exhaust gas. Here, the temperature of the exhaust gas may be measured in the vicinity of the exhaust port 202 of the exhaust manifold 26 by a temperature sensor included in the sensor 12, or may be estimated from, for example, an outside air temperature, an intake air temperature, or the like. Moreover, the flow rate of the exhaust gas may be measured by a flow rate sensor, or may be estimated from the rotation speed, load, or the like of the engine main body 2.

In short, the generation of deposits in the first SCR device 51 largely depends on the wall surface temperature of the exhaust path 28 with which urea water as a reducing agent collides. As the injection amount of urea water increases, the wall surface temperature decreases due to latent heat of vaporization when urea water collides with the wall surface. As an example, when the wall surface temperature is 195° C or lower, deposits are easily generated. Therefore, when the temperature of the exhaust gas is high and the wall surface temperature is sufficiently high, deposits are less likely to be generated even if the injection amount of urea water is increased, so that the upper limit value of the supply amount of the reducing agent of the first reducing agent supply device 56 can be increased.

As described above, by determining the upper limit value of the supply amount of the reducing agent of the first reducing agent supply device 56 according to the temperature and flow rate of the exhaust gas instead of simply suppressing the supply amount of the reducing agent, the supply amount of the reducing agent of the first reducing agent supply device 56 can be increased in a situation where deposits are less likely to be generated such as a situation where the temperature of the exhaust gas is sufficiently high. Therefore, it is possible to avoid limiting the supply amount of the reducing agent of the first reducing agent supply device 56 more than necessary and decreasing the purification rate of nitrogen oxides in the first SCR device 51.

Moreover, when the supply amount of the reducing agent of the first reducing agent supply device 56 is limited by the upper limit value, the control unit 11 increases the supply amount of the reducing agent of the second reducing agent supply device 57 by a compensation amount corresponding to the limited amount. That is, the decrease in the purification rate of nitrogen oxides in the first SCR device 51 caused by limiting the supply amount of the reducing agent of the first reducing agent supply device 56 can be compensated by the second SCR device 52 by increasing the supply amount of the reducing agent of the second reducing agent supply device 57. As a result, a desired purification rate of nitrogen oxides can be realized.

### 4. Modifications

Modifications of the first embodiment will be described one by one below. The modifications described below can be applied in combination as appropriate.

The engine system 1 in the present disclosure includes a computer system as the control unit 11. The computer system mainly includes one or more processors and one or more memories as hardware. The processor executes a program recorded in the memory of the computer system to implement a function as the control unit 11 in the present disclosure. The program may be prerecorded in the memory of the computer system, may be provided through a telecommunication line, or may be recorded and provided in a non-transitory recording medium, such as a memory card, an optical disk, or a hard disk drive, which is readable by the computer system. Moreover, some or all of the functional units included in the control unit 11 may be configured by an electronic circuit.

Moreover, it is not essential for the engine system 1 that at least some functions of the engine system 1 are integrated in one housing, and the components of the engine system 1 may be provided in a plurality of housings in a distributed manner. For example, the control unit 11 may be separated into a control unit of the exhaust gas recirculation system 4 and a control unit of the aftertreatment system 5. Conversely, in the first embodiment, the functions distributed over a plurality of devices may converge into one housing.

The engine main body 2 is not limited to a diesel engine using light oil as fuel, and may be, for example, a gasoline engine using gasoline as fuel, a hydrogen fueled internal combustion engine using hydrogen as fuel, or the like. Further, the engine system 1 may be a so-called dual-fuel engine (DF engine) that can cope with both a premix combustion method in which gaseous fuel is mixed with air and then introduced into a combustion chamber and a diffusion combustion method in which liquid fuel is injected into a combustion chamber and burned. Here, the gaseous fuel is hydrogen as an example, and the liquid fuel is fossil fuel (light oil, gasoline, or the like) as an example. More specifically, by using light oil as liquid fuel, the engine system 1 can cope with both a gas mode using hydrogen as fuel and a diesel mode using light oil as fuel. Here, in the gas mode, a small amount of liquid fuel (light oil or the like) may be further used as an ignition fuel.

Further, at least a part of the engine system 1 is not limited to being mounted on the machine body of the moving object, and may be provided separately from the machine body of the moving object. As an example, in a case where the control unit 11 is embodied by a server device provided separately from the machine body of the moving object, the control unit 11 can control the engine system 1 by communication between the server device and (a communication device of) the moving object. At least some functions of the control unit 11 may be realized by a cloud (cloud computing) or the like.

Moreover, the moving object on which the engine system 1 is mounted is not limited to the tractor, and the engine system 1 is used for other moving objects such as a work vehicle, a ship, and a flying object. The engine system 1 may be used for other than the moving object.

Moreover, the engine system 1 is not limited to the in-line multi-cylinder engine in which the plurality of cylinders 211 are arranged in series, and may be, for example, a V-type engine in which the plurality of cylinders 211 are arranged in a V shape with the rotation axis Ax1 of the crankshaft 23 as a vertex, or a horizontally opposed engine.

Moreover, the engine system 1 may be a single-cylinder engine including only one cylinder 211. Moreover, the engine system 1 is not limited to the supercharged engine, and may be a naturally charged engine without the supercharger 6.

### Second embodiment

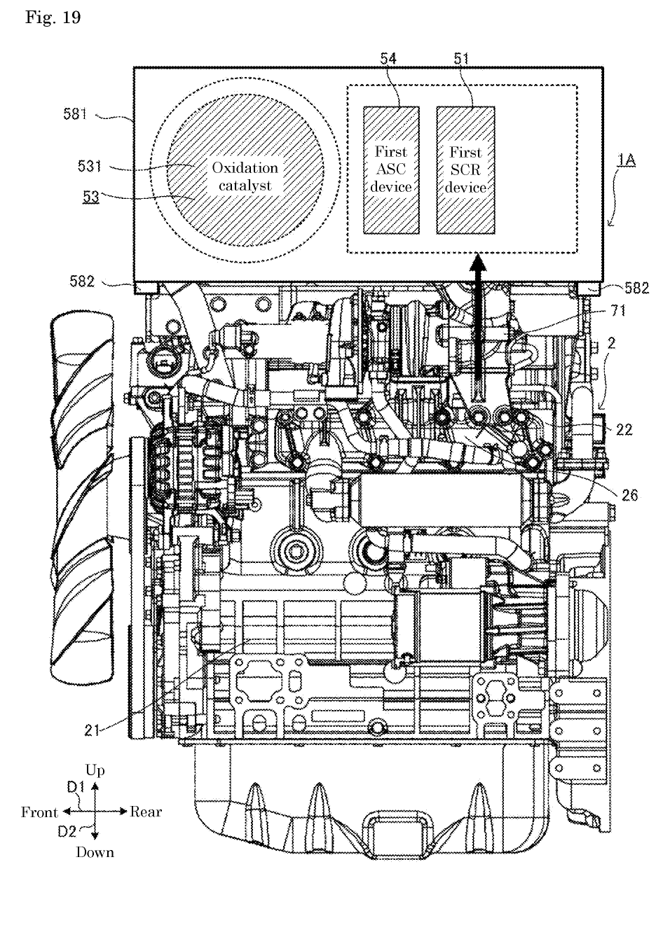

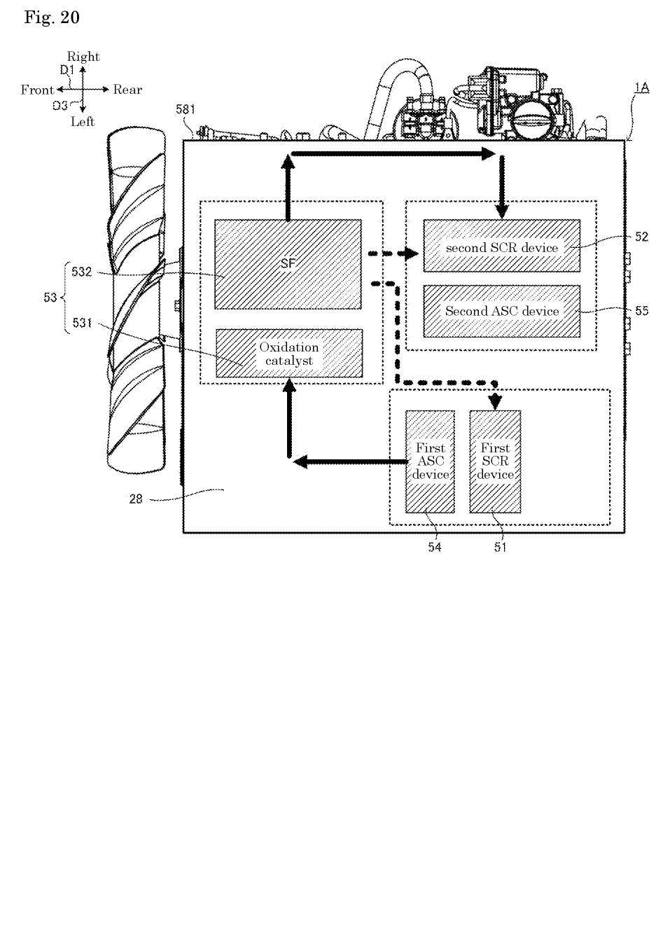

As illustrated in FIGS. 19 and 20, an engine system 1A according to a second embodiment is different from the first embodiment in the configuration of the aftertreatment system 5. Hereinafter, the common reference numerals are assigned to configurations similar to those of the first embodiment, and the descriptions thereof are omitted as appropriate.

In the embodiment, the aftertreatment system 5 includes a case 581 that houses the SCR device 51 and the emission control device 53. The SCR device 51 and the emission control device 53 are connected by a path including part of an internal space of the case 581. The case 581 has, for example, a rectangular parallelepiped shape flat in the up-down direction D2, and houses therein the first SCR device 51, the first ASC device 54, the emission control device 53 (the oxidation catalyst 531 and the soot filter 532), the second SCR device 52, and the second ASC device 55. That is, the first SCR case 501 and the second SCR case 502 are not provided separately, but the components of the aftertreatment system 5 are housed in the case 581 as one body.

In the embodiment, as an example, the case 581 is installed above the engine main body 2. Here, the case 581 is supported by a support bracket 582 with respect to the engine main body 2. According to this configuration, the support structure (support bracket 582) of the case 581 can be simplified as compared with the case where the first SCR case 501 and the second SCR case 502 are separately provided. Further, since there is no need to ensure a clearance between the first SCR case 501 and the second SCR case 502, downsizing is easily achieved.

Here, by forming an appropriate partition in the internal space of the case 581, a path (exhaust path 28) through which exhaust gas passes is formed in the case 581. Specifically, the path is formed in the internal space of the case 581 such that the exhaust gas passes through the first SCR device 51, the first ASC device 54, the oxidation catalyst 531, the soot filter 532, the second SCR device 52, and the second ASC device 55 in this order. An exhaust inlet in the case 581 is connected to the supercharger 6 by the connection path 71.

In short, since the inside of the case 581 is used as the path (exhaust path 28) of the exhaust gas, the pipe as the exhaust path 28 can be omitted, which facilitates configuration simplification and downsizing. Further, since the plurality of components of the aftertreatment system 5 including the SCR device 51 and the emission control device 53 can be held in the case 581 as one body, rigidity of the aftertreatment system 5 can be easily ensured.

Moreover, the path (connection path 71) of the exhaust gas to the inlet of the SCR device 51 may also be formed in the internal space of the case 581. In this case, the degree of freedom in arranging the SCR device 51 in the case 581 is improved. For example, the arrangement of the SCR device 51 can be changed or the arrangement of the downstream path 73 can be changed in accordance with a demand for mounting the first reducing agent supply device 56 and the second reducing agent supply device 57 or accessory components such as sensors. For example, the first SCR device 51 or the second SCR device 52 whose temperature is desired to be maintained can be disposed at a position away from a fan.

Moreover, the case 581 has a heat transfer structure for transferring heat from the emission control device 53 to the SCR device 51. In FIG. 20, the transfer of heat (heat transfer) is indicated by the broken line arrows. That is, in the embodiment, the case 581 is made of metal, the case 581 itself or the internal space of the case 581 has the heat transfer structure, and heat is transferred from the emission control device 53 to the SCR device 51, both of which are housed in the same case 581. Further, since the case 581 houses not only the first SCR device 51 but also the second SCR device 52, heat is transferred from the emission control device 53 to the second SCR device 52.

Accordingly, the heat accumulated in the soot filter 532 having a relatively large heat capacity can be transferred to the SCR device 51. Therefore, for example, even when the temperature of the exhaust gas is low immediately after the start of the engine main body 2 or at the time of light load, the time required for the SCR device 51 to reach the activation temperature can be shortened. Similarly, the time required for the second SCR device 52 to reach the activation temperature can be shortened. Further, cost reduction is easily achieved as compared with a case where a heat insulation structure is adopted for external piping.

In the embodiment, in the aftertreatment system 5, it is not essential that the connection path 71 include the first path 711, the second path 712, and the coupling portion 713. That is, the aftertreatment system 5 only needs to include the emission control device 53, the (first) SCR device 51, and the case 581. The emission control device 53 captures the particulate matter in the exhaust gas discharged from the engine main body 2. The SCR device 51 is located between the exhaust port 202 of the engine main body 2 and the emission control device 53. The case 581 houses the SCR device 51 and the emission control device 53. The SCR device 51 and the emission control device 53 are connected by a path including part of an internal space of the case 581.

The configurations according to the second embodiment (including the modifications) can be employed in combination with the various configurations described in the first embodiment (including the modifications) as appropriate.

### Additional notes of invention

Hereinafter, an outline of the invention extracted from the above-described embodiments will be additionally described. Note that configurations and processing functions described in the following additional notes can be selected to be combined as desired.

### Additional note 1

A control method of an aftertreatment system including a first SCR device located on an exhaust path through which exhaust gas discharged from an engine main body passes, a second SCR device located on the exhaust path and on a downstream side of the first SCR device in a flow direction of the exhaust gas, a first reducing agent supply device that supplies a reducing agent to the first SCR device, and a second reducing agent supply device that supplies the reducing agent to the second SCR device, the control method including
individually controlling a supply amount of the reducing agent of each of the first reducing agent supply device and the second reducing agent supply device.

### Additional note 2

The control method of the aftertreatment system according to Additional note 1, in which
the aftertreatment system further includes an emission control device that is located between the first SCR device and the second SCR device in the exhaust path and captures particulate matter in the exhaust gas, and
the supply amount of the reducing agent of each of the first reducing agent supply device and the second reducing agent supply device is controlled such that a regeneration capability of the emission control device is equal to or higher than a predetermined value.

### Additional note 3

The control method of the aftertreatment system according to Additional note 2, in which
the supply amount of the reducing agent of each of the first reducing agent supply device and the second reducing agent supply device is controlled depending on whether a regeneration mode of the emission control device is a passive regeneration mode or an active regeneration mode.

### Additional note 4

The control method of the aftertreatment system according to any one of Additional notes 1 to 3, in which
the supply amount of the reducing agent of each of the first reducing agent supply device and the second reducing agent supply device is controlled according to a catalyst temperature of each of the first SCR device and the second SCR device.

### Additional note 5

The control method of the aftertreatment system according to Additional note 4, in which
when the catalyst temperatures of both the first SCR device and the second SCR device are equal to or higher than an activation temperature and an emission control device that is located between the first SCR device and the second SCR device in the exhaust path and captures particulate matter in the exhaust gas, in the aftertreatment system, is performing regeneration in an active regeneration mode, the supply amount of the reducing agent of the first reducing agent supply device is made larger than the supply amount of the reducing agent of the second reducing agent supply device.

### Additional note 6

The control method of the aftertreatment system according to Additional note 4 or 5, in which
when the catalyst temperatures of both the first SCR device and the second SCR device are equal to or higher than the activation temperature, the supply amount of the reducing agent of each of the first reducing agent supply device and the second reducing agent supply device is controlled according to an inlet temperature of an emission control device that is located between the first SCR device and the second SCR device in the exhaust path and captures particulate matter in the exhaust, in the aftertreatment system.

### Additional note 7

The control method of the aftertreatment system according to Additional note 6, in which
when the catalyst temperatures of both the first SCR device and the second SCR device are equal to or higher than the activation temperature and the inlet temperature of the emission control device is equal to or higher than a predetermined temperature, the supply amount of the reducing agent of the first reducing agent supply device is made larger than the supply amount of the reducing agent of the second reducing agent supply device.

### Additional note 8

The control method of the aftertreatment system according to Additional note 6 or 7, in which
when the catalyst temperatures of both the first SCR device and the second SCR device are equal to or higher than the activation temperature and the inlet temperature of the emission control device is lower than the predetermined temperature, the supply amount of the reducing agent of the second reducing agent supply device is made larger than the supply amount of the reducing agent of the first reducing agent supply device.

### Additional note 9

The control method of the aftertreatment system according to any one of Additional notes 6 to 8, in which
when the catalyst temperature of only the first SCR device of the first SCR device and the second SCR device is equal to or higher than the activation temperature, the reducing agent is supplied only from the first reducing agent supply device of the first reducing agent supply device and the second reducing agent supply device.

### Additional note 10

The control method of the aftertreatment system according to any one of Additional notes 6 to 9, in which
when the catalyst temperature of only the second SCR device of the first SCR device and the second SCR device is equal to or higher than the activation temperature, the reducing agent is supplied only from the second reducing agent supply device of the first reducing agent supply device and the second reducing agent supply device.

### Additional note 11

The control method of the aftertreatment system according to any one of Additional notes 1 to 10, further including
determining an upper limit value of the supply amount of the reducing agent of the first reducing agent supply device according to a temperature and flow rate of the exhaust gas.

### Additional note 12

The control method of the aftertreatment system according to Additional note 11, further including
increasing, when the supply amount of the reducing agent of the first reducing agent supply device is limited by the upper limit value, the supply amount of the reducing agent of the second reducing agent supply device by a compensation amount corresponding to the limited amount.

### Additional note 13

A control program for causing one or more processors to
execute the control method of the aftertreatment system according to any one of Additional notes 1 to 12.

### Additional note 14

An aftertreatment system including:
a first SCR device located on an exhaust path through which exhaust gas discharged from an engine main body passes;
a second SCR device located on the exhaust path and on a downstream side of the first SCR device in a flow direction of the exhaust gas;
a first reducing agent supply device that supplies a reducing agent to the first SCR device;
a second reducing agent supply device that supplies the reducing agent to the second SCR device; and
a control unit that individually controls a supply amount of the reducing agent of each of the first reducing agent supply device and the second reducing agent supply device.

### Additional note 15

An engine system including:
the aftertreatment system according to Additional note 14; and
the engine main body.

### LIST OF REFERENCE SIGNS

1, 1A Engine system

2 Engine main body

5 Aftertreatment system

11 Control unit

28 Exhaust path

51 First SCR device

52 Second SCR device

53 Emission control device

56 First reducing agent supply device

57 Second reducing agent supply device

71 Connection path

1. A control method of an aftertreatment system including a first SCR device located on an exhaust path through which exhaust gas discharged from an engine main body passes, a second SCR device located on the exhaust path and on a downstream side of the first SCR device in a flow direction of the exhaust gas, a first reducing agent supply device that supplies a reducing agent to the first SCR device, and a second reducing agent supply device that supplies the reducing agent to the second SCR device, the control method comprising:
individually controlling a supply amount of the reducing agent of each of the first reducing agent supply device and the second reducing agent supply device.

2. The control method of the aftertreatment system according to claim 1, wherein
the aftertreatment system further includes an emission control device that is located between the first SCR device and the second SCR device in the exhaust path and captures particulate matter in the exhaust gas, and
the supply amount of the reducing agent of each of the first reducing agent supply device and the second reducing agent supply device is controlled such that a regeneration capability of the emission control device is equal to or higher than a predetermined value.

3. The control method of the aftertreatment system according to claim 2, wherein
the supply amount of the reducing agent of each of the first reducing agent supply device and the second reducing agent supply device is controlled depending on whether a regeneration mode of the emission control device is a passive regeneration mode or an active regeneration mode.

4. The control method of the aftertreatment system according to claim 1, wherein
the supply amount of the reducing agent of each of the first reducing agent supply device and the second reducing agent supply device is controlled according to a catalyst temperature of each of the first SCR device and the second SCR device.

5. The control method of the aftertreatment system according to claim 4, wherein
when the catalyst temperatures of both the first SCR device and the second SCR device are equal to or higher than an activation temperature and an emission control device that is located between the first SCR device and the second SCR device in the exhaust path and captures particulate matter in the exhaust gas, in the aftertreatment system, is performing regeneration in an active regeneration mode, the supply amount of the reducing agent of the first reducing agent supply device is made larger than the supply amount of the reducing agent of the second reducing agent supply device.

6. The control method of the aftertreatment system according to claim 4, wherein
when the catalyst temperatures of both the first SCR device and the second SCR device are equal to or higher than the activation temperature, the supply amount of the reducing agent of each of the first reducing agent supply device and the second reducing agent supply device is controlled according to an inlet temperature of an emission control device that is located between the first SCR device and the second SCR device in the exhaust path and captures particulate matter in the exhaust, in the aftertreatment system.

7. The control method of the aftertreatment system according to claim 6, wherein
when the catalyst temperatures of both the first SCR device and the second SCR device are equal to or higher than the activation temperature and the inlet temperature of the emission control device is equal to or higher than a predetermined temperature, the supply amount of the reducing agent of the first reducing agent supply device is made larger than the supply amount of the reducing agent of the second reducing agent supply device.

8. The control method of the aftertreatment system according to claim 6, wherein
when the catalyst temperatures of both the first SCR device and the second SCR device are equal to or higher than the activation temperature and the inlet temperature of the emission control device is lower than the predetermined temperature, the supply amount of the reducing agent of the second reducing agent supply device is made larger than the supply amount of the reducing agent of the first reducing agent supply device.

9. The control method of the aftertreatment system according to claim 6, wherein
when the catalyst temperature of only the first SCR device of the first SCR device and the second SCR device is equal to or higher than the activation temperature, the reducing agent is supplied only from the first reducing agent supply device of the first reducing agent supply device and the second reducing agent supply device.

10. The control method of the aftertreatment system according to claim 6, wherein
when the catalyst temperature of only the second SCR device of the first SCR device and the second SCR device is equal to or higher than the activation temperature, the reducing agent is supplied only from the second reducing agent supply device of the first reducing agent supply device and the second reducing agent supply device.

11. The control method of the aftertreatment system according to claim 1, further comprising:
determining an upper limit value of the supply amount of the reducing agent of the first reducing agent supply device according to a temperature and flow rate of the exhaust gas.

12. The control method of the aftertreatment system according to claim 11, further comprising:
increasing, when the supply amount of the reducing agent of the first reducing agent supply device is limited by the upper limit value, the supply amount of the reducing agent of the second reducing agent supply device by a compensation amount corresponding to the limited amount.

13. A computer-readable non-volatile medium storing a control program for causing one or more processors to execute
the control method of the aftertreatment system according to claim 1.

14. An aftertreatment system comprising:
a first SCR device located on an exhaust path through which exhaust gas discharged from an engine main body passes;
a second SCR device located on the exhaust path and on a downstream side of the first SCR device in a flow direction of the exhaust gas;
a first reducing agent supply device that supplies a reducing agent to the first SCR device;
a second reducing agent supply device that supplies the reducing agent to the second SCR device; and
a control unit that individually controls a supply amount of the reducing agent of each of the first reducing agent supply device and the second reducing agent supply device.

15. An engine system comprising:
the aftertreatment system according to claim 14; and
the engine main body.
